(19) United States
(12) Patent Application Publication
(10) Pub. No.: US 2026/0017712 A1
(43) Pub. Date: Jan. 15, 2026

(54) System and Methods for Optimizing Ingestion of Social Network Content for Purposes of Identifying Content of Interest or Concern

(71) Applicant: Pendulum Intelligence, Inc., Seattle, WA (US)

(72) Inventors: Samuel Clark, Seattle, WA (US); Ammar Haris, Lake Forest Park, WA (US); Daniel Zhu, Kirkland, WA (US); Abdurrahman Elbuni, Waterloo (CA); Nikolay Trandev, Bremerton, WA (US); Mark Listes, Seattle, WA (US)

(21) Appl. No.: 19/261,494

(22) Filed: Jul. 7, 2025

Related U.S. Application Data
(60) Provisional application No. 63/670,283, filed on Jul. 12, 2024.

(51) Int. Cl. G06Q 40/00

(52) U.S. Cl. CPC G06Q 40/00

(57) ABSTRACT

Systems, apparatuses, and methods for more effectively monitoring social network and social media posts to assist in identifying posted video, audio, or textual content that may be of interest or concern to a specific entity. This may comprise implementation of a process or technique to select a platform to extract content from, selecting one or more channels or sub-channels on that platform from which to extract content of interest or concern, identifying and subsequently extracting posts expected to contain content of interest or concern, post-processing the extracted content to place it into a form in which it can better be evaluated, and based on the extracted and processed content, causing one or more actions or events to occur.

### CROSS REFERENCE TO RELATED APPLICATION

This application claims the benefit of U.S. Provisional Application No. 63/670,283, filed Jul. 12, 2024, entitled “System and Methods for Optimizing Ingestion of Social Network Content for Purposes of Identifying Content of Interest or Concern”, the disclosure of which is incorporated, in its entirety (including the Appendix) by this reference.

### BACKGROUND

Conventional approaches to identifying posted video, audio, or textual content that may be of interest or concern are typically limited to platforms (such as social networks) that enable use of an API to access content. However, this approach is unable to effectively access and evaluate a substantial portion of posted content and may be limited in the types of content it is able to access.

This limitation is significant as nearly all major social media platforms (with the main exceptions being Twitter/X and Reddit) do not provide public APIs to assist in monitoring content. For platforms in which APls are not available, a conventional approach would be to monitor all publicly available channels that can be discovered by ingesting and processing all of the available posts. However, this approach is likely to be prohibitive with regards to cost due to the scale of major social media platforms.

As an alternative, and in to attempt to limit costs, one could monitor the top set of channels (in terms of number of posts or percentage of posts, as examples) on a platform. However, this may provide an incomplete view into the topics or narratives of interest, given that many topics or narratives of interest to a specific entity (e.g., a customer, organization, brand, or user) might only appear in a small percentage of posted content.

Embodiments of the systems, apparatuses, and methods disclosed herein are directed to enabling the tracking of a significantly larger percentage of content or narratives of interest across a variety of video, audio, and textual platforms than previously used approaches, and to solving the described and related problems of conventional approaches individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments of the disclosure are directed to systems, apparatuses, and methods for more effectively monitoring social network and social media posts to assist in identifying posted video, audio, or textual content that may be of interest or concern to a specific entity (such as a governmental entity, business, brand, or group, as non-limiting examples). In some embodiments, this may include elements, components, processes, operations, or functions for performing the following tasks:
Channel discovery, where a channel is a source or propagator of content of potential interest;
Channel ROI estimation—this serves to provide guidance on whether ingesting/extracting content from a channel is likely to be productive and/or cost-effective with regards to resource use;
Post-processing of identified content on a channel, which may include one or more of performing optical character recognition (OCR), image captioning, and audio transcription functions or operations to enable “matching” one or more narratives to posted content; and
Content ingestion optimization to better utilize computational (and/or other) resources for the identification, extraction, and post-extraction processing of content by more efficiently selecting one or more of a channel from which to obtain content, a sub-channel or category of content, and a set of posts/content to extract and process.

Embodiments may comprise implementation of a process or technique to select a social network or other type of platform to extract content from, selecting one or more channels or sub-channels on that platform from which to extract content of interest or concern, identifying and subsequently extracting posts expected to contain content of interest or concern, post-processing the extracted content to place it into a form in which it can better be evaluated and “matched” to a narrative, and based on the extracted and processed content, causing one or more actions or events to occur. The resulting action or event may depend upon the reason for seeking to identify content that matches a narrative (e.g., identifying potential harm to a brand or misinformation), the type of potential harm from the posted content (physical, brand, financial, etc.), or other purpose for the identification, extraction, and processing of the content.

In one non-limiting example, the resulting action or event may be to generate a notification of potentially harmful content to a regulatory agency or enforcement entity. In another non-limiting example, the action or event may be to notify an entity (such as a business or advertiser) that the content may result in economic or reputational harm so that the entity may take action to correct the content or negate its potentially harmful impact. In yet another non-limiting example, the action or event may be to associate the content with a warning or indication that it represents misinformation, misleading information, or unverified information.

In some embodiments, one or more metrics may be generated and then used as part of a ruleset, heuristic, trained model, or algorithm to determine one or more of when (or how often) to search for and extract content, what channels or sub-channels to extract content from, what posted content to extract, what portion of the extracted content to post-process, and/or how to respond to the extracted content. In one embodiment, an iterative process may be used, where a ruleset, heuristic, model, or algorithm may be modified based on data collected or identified during an initial identification of potentially useful channels, sub-channels, or content.

In one embodiment, a set of processes or software implemented tools are provided to enable monitoring of social network and social media posts to assist in identifying posted video, audio, or textual content that may be of interest or concern to a specific entity. In one embodiment, these processes may be performed in response to the execution of a set of instructions by a processor or processors and include one or more of the following steps, stages, methods, operations, or functions, with certain of those implemented by a server or platform and others by a client device or application:

### Backend/Server/Platform Side

Identify and collect posts and form snippets from known channels for later use in comparing to a narrative;
   All snippets that have been ingested remain in a data lake;
   After identifying a channel, the system ingests a variety of posts from it and generates snippets from these posts;
      This initial data may be used to estimate a channel's ROI (which can be used to determine whether to continue ingesting data from the channel going forward and if so, at what cadence);
   One or more examples of “business logic” or rules may be used to identify channels for extraction of content based on follower count, subject matter, or other indication of potential relevance to one or more narratives;
Implement and/or Execute a Process to Discover Channels of Possible Interest;
   Use one or more of contextual data, links, follower/following data, channel metadata, post metadata, crawling/scraping of a webpage, performing a keyword search or other form of search;
Implement and/or Execute a Process to Estimate a Channel's ROI (return on investment) for each of the discovered channels;
   Where the ROI is a measure that may be used to monitor and if needed, control computational resource (or other resource) usage based on the expected ROI associated with monitoring and/or extracting content from a specific channel;
   If desired, generate/calculate one or more of the described micro scores to assist in calculating or estimating the ROI, wherein a micro score represents a metric indicative of one or more of:
      Number of narrative library matches;
   In one embodiment, this “library” is a collection of narratives created internally by the assignee that are believed to be of interest to a large number of customers (for example, for corporate communications teams, there's likely to be interest in boycotts, inflation, executive compensation, and legal issues, as example topics of discussion, so a narrative for each of these topics can be created and provided to users/customers);
      Number of overall narrative matches;
      Number of overall snippets in a corpus or subset of the corpus;
   Train a ML model to predict the ROI for a channel using the generated/calculated data (such as the micro scores, as one example);
   In one embodiment, the micro scores may be combined to create a composite score and the composite score used to prioritize which channels to ingest data from. However, the weighting for each micro score may involve “business logic” and would be company/user dependent (i.e., some companies may want to prioritize matches for their own “library of narratives” over customer narratives or vice versa);
      The composite score generated from the micro scores is not needed for purposes of training the ROI prediction model as each micro score may be generated/predicted independently by a separate model;
Implement and/or Execute a Process to Estimate the ROI of Additional Processing that may be Needed for a Post Extracted from a Specific Channel (in one embodiment, this stage estimates the cost of processing as well as a likelihood of generating narrative matches). In some embodiments, this may involve one or more of the following processes;
   Optical Character Recognition (OCR);
   Image Captioning;
   Transcription;
   Training a ML model or models to predict the amount or extent one or more of these processing operations is expected (predicted) to be needed;
Optimize the Content Ingested/Extracted from a Channel. This “optimization” process may be based on consideration of one or more factors or use of one or more techniques, including but not limited to;
   Based on the determined micro scores applicable for that channel; and/or
   Based on an “explore and exploit” approach as defined in one non-limiting example by;
      Add all X channels that business logic for a user requires;
      Exploit—add the Y channels with the highest predicted ROI;
      Explore—add the Z channels with the highest predicted ROI that aren't in X or Y and have one of the following limitations;
         Z1=the system has not ingested post data for them yet;
         Z2=the system has not ingested post data in over 90 days (or other more optimal threshold);
Extract content from the channel(s) or sub-channels identified as having a sufficient ROI to justify processing and resource usage;
   Although processing usage is typically considered the “resource” of concern, others may be considered when deciding which channels or sub-channels to extract content from;
Process the extracted content into snippets, wherein a “snippet” is a slice or section (up to approximately a paragraph in length in some embodiments) of a “post” that is more convenient for purposes of being evaluated and reviewed. One or more of the following can be used as sources to identify and/or be part of a snippet formed from a post:
   Post title/description/hashtags;
   Transcripts from video and/or audio content; and
   Text contained in images (which may be determined using OCR or other technique);
Assemble a Corpus of Snippets from the Content Extracted from One or More Channels;
Receive/Define a narrative for a specific user, wherein a narrative consists of a “model” or “definition” that is used to determine whether a given “snippet”, post, or segment of content is a “match” for the given narrative (i.e., a narrative is a way of defining one or more characteristics of posted content/snippets being sought for purposes of further processing and evaluation). As non-limiting examples, a narrative may be defined:
   Using Boolean operator connected keywords; and/or
   Using an NLP technique or model;
   In one example, a Boolean combination could be used initially, followed by forming a prompt for an LLM to determine if a snippet is discussing the desired topic and not one with similar or the same terms (such as a name that is also used to refer to a company or a company name that is the same or similar to a person of interest);
Match/Classify the user narrative(s) to one or more snippets in the corpus that satisfy (i.e., “match”) the narrative;
   Here, matching is based on a comparison between a narrative and a snippet, typically with reference to a similarity metric;
   Non-limiting examples of such a comparison or matching technique include one or more of keyword matching, semantic similarity (based on generating embeddings and performing a comparison or grouping of embeddings), or other functionally similar technique.

### Client/Application Side.

Enable user to specify keywords or other form of a narrative that represents their interest or concern;
   In one embodiment, a narrative may be generated using a generative technique that receives a prompt and generates several sentences that describe a situation of concern or provides a list of keywords or related topics;
Enable user to specify the processing or operations they desire to be performed on the resulting “matches” between the specified keywords or other form of narrative and content found posted to a channel (i.e., snippets derived from content posted to a channel). Non-limiting examples of such processing include;
   Trend analysis (number of posts/snippets matching narrative over time, or other countable measure);
   Prediction or indication of a risk to user's interests (where these may include safety, brand, reputation, misinformation, disinformation, or other concern or interest);
   Filtering and analysis or evaluation (e.g., categorize, label, evaluate risk or other characteristic) the matches and related data and if desired, apply one or more of the categories of community information or threatening language, determine sentiment or use a process for name entity recognition, as non-limiting examples;
   As one example, this could be used to assist a user/customer to better understand which entities or topics are receiving a greater share of the mentions in content;
Present results of the further filtering, processing, or other operations to the user;
   In a suitable or specified form, such as one or more of a table, listing, graph, set of links to content, examples of most relevant snippets and indication of match (or measure of confidence in a match) to specific narrative(s) or categories. In one embodiment, these results may be presented on a client device or provided as a document on the server or platform that can be accessed using the client device.

In one embodiment, the disclosure is directed to a system, apparatus, and method to enable monitoring of social network and social media posts to assist in identifying posted video, audio, or textual content that may be of interest or concern to a specific entity. The system or apparatus may include a set of computer-executable instructions stored in (or on) a memory or data storage component (such as one or more non-transitory computer-readable media) and one or more electronic processors. When executed by the processors, the instructions cause the processors (or a device, system, server, or apparatus of which they are part) to perform a set of operations that implement an embodiment of the disclosed and/or described method or methods.

In one embodiment, the disclosure is directed to a set of computer-executable instructions stored in (or on) one or more non-transitory computer-readable media, wherein when the set of instructions are executed by one or more electronic processors, the processors (or a device, system, server, or apparatus of which they are part) perform a set of operations that implement an embodiment of the disclosed and/or described method or methods.

In some embodiments, the systems and methods disclosed and/or described herein may provide services or functionality through a SaaS or multi-tenant platform. The platform provides access to multiple entities, each with a separate account and associated data storage. Each account may access one or more services, a set of which are instantiated in their account, and which implement one or more of the methods or functions disclosed and/or described herein.

Other objects and advantages of the systems, apparatuses, and methods disclosed may be apparent to one of ordinary skill in the art upon review of the detailed description and the included figures. Throughout the drawings, identical reference characters and descriptions indicate similar, but not necessarily identical, elements. While the embodiments disclosed and/or described herein are susceptible to various modifications and alternative forms, specific embodiments are shown by way of example in the drawings and are described in detail herein. However, embodiments of the disclosure are not limited to the exemplary or specific forms described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1 is a flow diagram illustrating a set of processes, operations, or functions that may be used to enable monitoring of social network and social media posts to assist in identifying posted video, audio, or textual content that may be of interest or concern to a specific entity, in accordance with an embodiment of the disclosure;

FIG. 2 is a diagram illustrating elements or components that may be present in a computing device or other form of processor configured to implement a method, process, function, or operation in accordance with some embodiments;

FIGS. 3-5 are diagrams illustrating an architecture for a multi-tenant or SaaS platform that may be used in implementing an embodiment of the systems and methods disclosed herein; and

FIG. 6 is an illustration of a process by which snippets from the full corpus of data are matched to a specific narrative.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter are described more fully herein with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that the disclosure will satisfy the statutory requirements and convey the scope of the disclosure to those skilled in the art.

The subject matter of the disclosure may be embodied in whole or in part as a system, as one or more methods, as one or more processing devices, or as a set of computer-executable instructions. Embodiments may take the form of a hardware implemented embodiment, a software implemented embodiment, or an embodiment combining software and hardware aspects. For example, in some embodiments, one or more of the operations, functions, processes, or methods disclosed and/or described herein may be implemented by a suitable processing component or components (such as a processor, microprocessor, CPU, GPU, TPU, QPU, state machine, or controller, as non-limiting examples). The processing component or components may be part of a client device, apparatus, server, network element, remote platform (such as a SaaS platform), an “in the cloud” service, or other form of computing or data processing system, device, or platform.

The processing component or components may be programmed with a set of executable instructions (e.g., software instructions), where the instructions may be stored on (or in) one or more suitable non-transitory computer-readable data storage elements. In some embodiments, the set of instructions may be conveyed to a user over a network (e.g., the Internet) through a transfer of instructions or transfer of an application that executes a set of instructions.

In some embodiments, the systems and methods disclosed herein may provide services or functionality through a SaaS or multi-tenant platform. The platform provides access to multiple entities, each with a separate account and associated data storage. Each account may correspond to a specific social media platform, a specific channel or sub-channel on that platform, a specific narrative, an entity interested in identifying and understanding specific posted content on a specific platform or platforms, a publisher of content, a brand, a governmental agency, a company, or an organization, as non-limiting examples. Each account may access one or more services, a set of which are instantiated in their account, and which implement one or more of the methods or functions disclosed and/or described herein.

In some embodiments, one or more of the operations, functions, processes, or methods disclosed herein may be implemented by a specialized form of hardware, such as a programmable gate array, application specific integrated circuit (ASIC), or the like. An embodiment of the disclosed methods (or a portion of them) may be implemented in the form of an application, a sub-routine that is part of a larger application, a “plug-in”, an extension to the functionality of a data processing system or platform, or other suitable form. The following detailed description is, therefore, not to be taken in a limiting sense.

As mentioned, embodiments may include elements, components, processes, operations, or functions for performing one or more of the following tasks:
Snippet formation from content posted on known channels (and from later discovered channels);
   This may include sampling posts on a channel, processing the sampled posts into snippets, and storage of the snippets in a data lake;
      In some embodiments, key words or topics may be used to identify potential content for transforming into snippets;
      In some embodiments, these snippets may be formed from content found to match a narrative in the library of narratives;
      The content may be identified and ingested at a regular basis from known channels with an expected ROI sufficient to justify use of the resources required for content extraction and processing;
      As additional channels and sub-channels are discovered, content from those may be extracted, formed into snippets, and stored in the data lake;
Channel discovery, where a channel is a source or propagator of content of potential interest;
   This may include sub-channels and is typically based on an indicator of possible relevance, such as the disclosed micro scores, a number of followers, or an indication of the subject matter of the posted content, as non-limiting examples;
Channel ROI estimation—this serves to provide guidance on whether ingesting/extracting content from a specific channel (and processing it further where needed) is likely to be productive with regards to use of computational or other resources;
   This may include consideration of post-processing of identified content, which may include performing one or more of OCR, image captioning, and audio transcription functions or operations; and
Content ingestion optimization to better utilize computational (or other) resources for the identification, extraction, and post-extraction processing of content by more efficiently selecting one or more of a channel from which to obtain content, a sub-channel or category of content, and a set of posts/content to extract and process.

The following is a more detailed and non-limiting description of one or more components, elements, functions, features, operations, or processes that may be present in an embodiment of the disclosed and/or described narrative tracking system. In this regard, the description includes the following topics:
Motivation for channel discovery and channel ROI estimation;
Single channel content ingestion;
Narrative matching/classification;
Contextual information about channels;
Channel discovery solutions;
Channel ROI estimation;
   This may include post-processing of extracted content—for example OCR, image captioning, and transcription ROI estimation;
Content ingestion optimization (based on consideration of channel or sub-channel ROI and/or other factors). As non-limiting examples, factors other than ROI that may be considered include;
   Cost of ingesting/processing data from a given platform (e.g., some platforms and modalities are more expensive, such as a situation where transcribing audio is more costly than scraping a text-based platform); or
   The perceived value of certain platforms to users compared to others (e.g., based on audience of users or demographic factors);
The optimization process may take into consideration a set of rules or heuristics to reduce the resource usage (e.g., limiting to a subset of creators or only using a title of an item of content, as examples), although this may reduce the coverage of the extraction process and reduce the value to some users;
Surfacing identified content (in the form of snippets) of possible interest in a web or client-based application;
   This may include graphs, risk measures, labels indicating a type of risk or concern, trend data, links to specific examples or an evaluation of content, etc.; and
Example end use cases and value propositions for an embodiment of the disclosure.

### Channel Discovery and Channel ROI Estimation

Before describing additional details regarding techniques for content ingestion optimization and other aspects of an embodiment of the disclosure, the following may be helpful in providing background and the context upon which one or more embodiments are based.

Embodiments may be used to identify and process posted content to determine if it matches (or is sufficiently close to) a “narrative” provided by a user. This may be performed for the purpose of monitoring the distribution and potentially the impact of content that reflects a narrative. The impact may take the form of a risk to a person or group, as representing potential harm to a brand, or as an indication of the “state of mind” or opinion of the entity that posted the content or an entity that subscribes to a specific channel.

The impact may also be the result of the posted content being a potential source of misinformation or disinformation. In such situations, the content may be of interest to those concerned about the impact of such information on an election, a decision made by a government agency, or a decision made by a set of people (such as consumers, voters, vendors, or employees, as non-limiting examples).

In the context of the disclosure, narratives are tracked by identifying relevant snippets of content on one or more of video, audio, and textual platforms. A narrative can either be defined by a user or internally by a team member of the assignee or other entity (such as one operating a platform or system to provide an embodiment of the disclosed and/or described services to end-users). Each narrative consists of (or is placed into the form of) a “model” or “definition” that is used to determine whether a given “snippet”, post, or segment of content is a “match” for the given narrative. In this sense, a narrative represents a way of defining one or more characteristics of posted content being sought for purposes of extraction, processing, and evaluation.

For example, in the simple case of a “Boolean keyword narrative definition” a narrative could be created that matches all snippets containing the keyword “Comcast” and this would match a snippet such as “I just signed up for Comcast internet service” but would not match the snippet “My internet service is awful.” In this example, a narrative definition includes one or more specific keywords and one or more connecting Boolean operators. More complex narrative definitions that leverage NLP models may be used, and examples are described in this disclosure. As mentioned, in one example, a Boolean combination could be used initially, followed by forming a prompt for an LLM to determine if a snippet is discussing the desired topic and not one with similar or the same terms.

In some embodiments, a “snippet” is a slice or section (up to roughly a paragraph in length as an example) of a “post” that is more efficient for purposes of being reviewed and evaluated. As non-limiting examples, one or more of the following can be used as sources to identify and/or be part of a snippet:
Post title/description/hashtags;
Transcripts from video and audio content;
Text contained in images; and
Model generated captions of an image or images (which may be obtained from a video).
   One or more of the above characteristics may be used to form a snippet from content on a previously known channel (or sub-channel) and/or a newly discovered channel (or sub-channel).

A corpus of snippets (in some cases organized or categorized by subject, potential concern or harm, indexed, labeled, or subject to other processing) may be stored in a data lake. The data lake may be regularly updated through “scraping” or other extraction process for posted content (e.g., daily scraping/extraction from platforms, channels, or sub-channels, or more frequently if desired). The posts are extracted from multiple “channels” hosted on one or more video, audio, and textual platforms, and subsequently converted into snippets. As will be described, this does not include all channels that may be available on a platform, but instead those expected to have posts that are more likely to satisfy a narrative (and which have an acceptable ROI measure).

In one embodiment, this is determined by the ROI “prediction” techniques described herein and refers to satisfying narratives a customer created or those created internally for the “library” of narratives. This is an important constraint as when operating at scale, it costs a non-trivial amount of money to check channels for new uploads and ingest and process the content in an upload, where the processing may include transcriptions of audio or generation of image captions (as examples).

To assist users or another entity to monitor (“track”) narratives of interest, in one embodiment, all narrative models/definitions associated with a user or entity (or other indicator of an account or task, such as a platform or category) are applied to each snippet in a corpus to determine which (if any) of the narratives the snippet matches. For a given narrative, the matched snippets can be reviewed, analyzed, and evaluated in a corresponding web application. The review and any further evaluation may be used for one or more purposes, examples of which are provided as part of this disclosure. In this way, an entity or user is associated with a set of narratives, each of which may be compared or “matched” to the snippets contained in a data lake (or a section of an indexed or organized corpus or data lake).

In one embodiment, there are two components or processes used to “match” a snippet to a narrative; a “retrieval” step and a “read” step (although this is optional for some uses). The “retrieval” step (in which Boolean keywords, or dense passage retrieval may be used) is computationally efficient, being similar to the way search engines index and retrieve web pages. This means that it is not strictly necessary to attempt to match a narrative to only a subset of the snippets in a corpus. The “read” step is typically not as efficient (being more computationally expensive), so an embodiment may first do a “retrieval” step to limit the number of snippets the “read” model is applied to.

### Optimized Content Ingestion

The narrative tracking approach disclosed and/or described herein is likely to be most helpful if a corpus consists of the “right” set of snippets (i.e., those sufficiently representative of a channel, sub-channel, or platform and correctly satisfying a definition of the desired content, as expressed in the form of a narrative). Unfortunately, for nearly all of the social media platforms/mediums of interest, there is not an API available to enable efficient finding of content on these platforms/mediums that is expected to match a particular narrative. An exception is Twitter/X, which provides an API to search for posts/tweets using Boolean keywords. This is one reason that the majority of narrative tracking approaches focus on this particular platform. However, this fails to provide a complete picture of the posted content across multiple platforms that may be of interest to an entity. As described, a matching process may involve simple keyword matching and/or use of an NLP technique to resolve possible ambiguities or otherwise assist in determining an accurate match between a snippet and a narrative.

In general, to identify a post/snippet that matches a specific narrative, the processing flow may implement the following tasks, methods, processes, functions, or operations, either separately or in combination:
Determine the channel or sub-channel that created/uploaded the post (or the post a snippet is a subsection of) through a mechanism other than directly searching for the snippet (given that no API may be available for this purpose);
Use the channel's post feed to find the post and scrape metadata and other relevant content regarding the post of interest or other posts on the channel;
In the case of a video platform, it may be necessary to transcribe the video and split the transcript into snippets;
In the case of an image platform, it may be necessary to apply OCR and split the text from the image into snippets or create an embedding for the image that makes it searchable.

However, while expected to be productive, this approach presents several challenges, among them:
Many platforms do not contain an “index” or “catalog” that provides information on all the channels on the platform, so one may have to “discover” channels by a separate process;
For the channels found or discovered, the disclosed system does not receive a “push notification” when the channel uploads a new post. Instead, the system must scrape the post feed (regularly) to discover if the channel has uploaded a new post. However, doing this at a high frequency can incur a significant computational cost;
Once a new video/audio/image post is found to have been uploaded, it is not known whether the post contains a snippet that would match a narrative prior to downloading the content of the post and either transcribing the audio or applying OCR to the visual data to generate a snippet or snippets;
   This is not the case for some textual content and/or metadata where the disclosed system or processes can rely on search engines to index the content and make it more easily accessible and interpretable. However, such metadata accounts for a limited number of matches on many platforms (for example, they represent less than ¼ of narrative matches on YouTube at present);
   Given the computational cost of downloading video/audio/image posts and applying transcription models and/or OCR, it may be (and typically is) cost prohibitive to do this for all channels and posts that the disclosed system is or becomes aware of.

As will be described in greater detail, to overcome these problems or limitations, the disclosed and/or described system and methods may incorporate one or more techniques to improve the likelihood of successful channel discovery and content extraction. These techniques may include one or more of:
Discover one or more of the valuable channels across the platforms supported (i.e., identify those channels most likely to contain content of interest);
   This may be based on a combination of keywords, a channel having users of other channels that have content that matches a narrative, advertising content directed at users, or channel metadata, as non-limiting examples;
Predict what subset(s) of the discovered channels are most likely to have posts that match a narrative of interest (this may be used to determine the cadence at which to ingest/scrape content from each channel);
   This prediction may be based on a calculation of expected ROI, a trained model, a ruleset, or a heuristic, as non-limiting examples;
Predict what subset(s) of posts/content from these channels contain snippets that match a narrative (this may be used to assist in determining whether audio/video content should be transcribed, or OCR should be applied to images);
   This prediction may be based on a calculation of expected ROI, a trained model, a ruleset, or a heuristic, as non-limiting examples.

These steps (alone or in combination) can be used to assist in reducing computational or other resource costs and the time required for analysis by focusing on posts/channels that are expected to be most relevant to identifying content of interest or concern (i.e., content that is most likely to match a narrative based on the narrative's topic, sentiment, or other aspect).

### Single Channel Content Ingestion

This section covers how posts from a single channel can be scraped and processed (how this operation is performed for multiple channels is described in greater detail in another section). The following approach applies to platforms/mediums for which an API is not available for use in identifying, accessing, and extracting data.

At present, an embodiment supports two types of “channels” (although other types or categories can also be supported):
Account channels;
   This is a primary type of channel. In this case, each “channel” is the account that is responsible for uploading content; and
Topic channels;
   This may be used for some platforms or networks (e.g., it is used for Reddit, where subreddits are a channel, 4chan, and a small number of other platforms).
      Each such account or topic channel has an associated page containing a feed of “posts” (these may include video, audio, image, or text content depending on the platform) that are in descending order by time/date of upload of the posts. Such platforms include YouTube, TikTok, Instagram, Bitchute, Rumble, and Reddit, as non-limiting examples.

To ingest content for an individual channel, in one embodiment, the system and methods perform the following steps, stages, functions, or operations:
Scrape the posts feed and identify all URLs for posts that are not currently in the data lake. In some cases, this could involve the following process flow:
   For some platforms, paginate using a headless browser (such as Selenium) to ensure the disclosed system finds all new posts (or up to X total posts or posts up to Y years old if it is a first scraping);
   In cases in which this is prohibitively expensive or resource intensive, it may be preferable to get 1 page of search results using HTTP requests (knowing that it's possible the system may miss new posts if the channel has uploaded a large number of posts since the last scraping);
   In some cases, may also need to use proxy servers or other approaches to scrape new posts for a channel.

For each new post that is identified and that is not presently in the data lake or other form of data storage, in one embodiment, the disclosed and/or described system does the following:
Use the post URL to scrape the following (if available):
   Post title, description, hashtags, views, comment counts, likes, and other potentially useful metadata;
   A non-limiting example of such metadata is location which may be of interest to a user who is seeking to better understand content posted from a specific region;
   URLs to linked or referenced video, audio, or image data;
   For posts with video or audio content, estimate the value (ROI) of transcribing the video or audio content (as described in greater detail herein). In cases where the estimated value is above an established threshold (which may be set and adjusted based on the results, or determined by a trained model), the disclosed system then does the following:
      Download the video/audio content;
      Use a 3rd party transcription service (such as DeepGram or AWS Transcribe) or an open-source transcription model (such as OpenAl's Whisper model) to generate a transcript for the video/audio;
   Similarly, for posts with image or video data, estimate the value of applying OCR and/or image captioning (as described in greater detail herein) to either the image or to sampled frames from the video. In cases where the estimated value is above an established threshold, the disclosed system does the following:
      Download the image or video;
      In the cases of videos, sample frames from the video;
      For the resulting images, use a 3rd party OCR or image captioning service (such as AWS Recognition or Azure Vision) to identify text in the image or generate a description of the image;
   The system then converts the resulting title, description, metadata (if useful), transcripts, OCR text, and image captions into “snippets”;
      This may be done by first splitting a data item into sentences (using an open-source library such as Spacy) or into paragraphs. The system then appends sentences/paragraphs until reaching the 60 word or 380-character limit, in which case a snippet is generated, and the disclosed system moves on to creating the next snippet;
   Finally, the disclosed system adds the post URL, collected metadata, and the generated snippets to the data lake (or to a specific section of the data lake).

### Narrative Matching/Classification

In the context of the disclosure, a “narrative” is both a general concept and may refer to a specific description of what a user is seeking to identify in a set of snippets. The word “narrative” is often considered synonymous with “story”. Herein it is meant to refer to one or more of the following:
“A story or representation used to give an explanatory or justificatory account of society, period, etc.” (see Oxford English Dictionary);
“A narrative is a way of presenting or understanding a situation or series of events that promotes a particular point of view or set of values.” (see Merriam-Webster dictionary).
   As an aside, some social scientists believe narratives are the primary way humans communicate ideas and make sense of the world (i.e., by developing a story or description of an event or situation).

Along with identifying if a narrative is being presented or discussed within a set of snippets, it is often important and valuable to determine whether a narrative is “disputed” or “supported” by other contributors to a channel or sub-channel. This can be an indication of the strength of the position expressed by the narrative. In some cases, knowledge about a community the content creator is a member of may be used as a signal for predicting/inferring this. This aspect is discussed in greater detail in the “Contextual Information About Channels” section of the disclosure.

Embodiments also support grouping sets of snippets, as this grouping may provide additional information of value. Non-limiting examples of potential types of snippet groupings include the following:
Narratives—based on the conceptual definition above (a story in some form). This is believed to be an important type of content grouping, given the impact of stories;
Topics—for example, all content discussing data breaches. For some topics, there is a notion of “Communities”. However, these are groupings of channels that discuss the topic in a large percentage of their snippets, not groupings of snippets themselves;
Named entities—for example, all snippets mentioning Zoom, the brand. These can be valuable in tracking narratives that may represent harm to a brand or reputation.

A narrative is typically created by a user and/or administrator of a platform that implements the disclosed and/or described processes. In one embodiment, a process of creating a narrative involves three main steps:
Narrative definition—a user provides the appropriate inputs to define the narrative (this may include keywords or concepts, and in some examples may be generated using a generative AI tool);
Narrative model creation—the provided definition is then used to create a model;
   In one sense, a “model” in the context of the disclosure is a form of a narrative that is capable of being compared to a snippet in a more computationally efficient manner. As non-limiting examples, two possible ways a narrative definition can be converted to a model are as follows:
      If the user provides or helps generate a labeled dataset (i.e., examples of snippets that do match the narrative and examples of snippets that don't match the narrative), these can be used to fine-tune an LLM (or smaller pretrained-language-model) so that it can accurately determine whether snippets “match” the narrative; or
      If a user provides a detailed description of what type of snippets should match the narrative, this can be used to create a prompt that then can be used by LLMs to determine if a given snippet matches the narrative;
      There are also ways to combine these techniques to create a “model” from the narrative definition;
      In addition, one can use the “Anchor/Boolean keywords” as defined in this disclosure to first filter down a set of the snippets in the corpus to a smaller subset before applying an LLM based model to each of these;
Narrative scoring—the model is then applied to all content in the corpus in order to identify content that “matches” the narrative. The content is represented by the snippets in a data lake;
   As one non-limiting example, a binary classification can be applied, where each snippet is given a probability of being a “match” to the narrative and if the probability is above 0.5, it is considered that the snippet is a “match”;
      This probability value can be varied based on the utility (or lack) of the results.

In one embodiment, to define a narrative, a user provides:
Anchor/Boolean keywords—these are keywords that must exist in the content for the content to be considered by subsequent steps as a match. They are combined or constructed using Boolean logic, with “and”, “or”, and “not” supported (as well as other common Boolean query operators, such as “near”);
(optional) A natural language description of the narrative—this is a short description of the narrative that may be used by a zero-shot learning model;
(optional) Labeled data—the user can label a small amount of data (e.g., a snippet or snippets) that is matched to a narrative based on keywords and/or an NLP description.

In some cases, a narrative can be tracked (i.e., matched to a snippet or snippets) with one or more keywords alone. For example, a narrative tracking all mentions of the entity “Comcast”. These are referred to as “keyword only” narratives and typically do not require further processing to create a “model”, since the “model” is the “anchor/Boolean keywords” defined by the user.

In other cases, it may be necessary to use an NLP based model to match a snippet to a narrative (or vice-versa). One such example is a narrative tracking mentions of the company “Zoom” (given that the word zoom is ambiguous, and its meaning depends on its context). These situations are referred to as “NLP narratives” or “intelligent narratives” and they are created using one or more of the processing steps or stages described herein.

To describe these steps in detail, the following borrows terminology from the Open Domain Question-Answering (OpenQA) NLP task (specifically, the terms and definitions for a “corpus”, “retriever”, and “reader”). The “full corpus” is the set of snippets that have been collected across all platforms that are supported (or, across a subset of such platforms based on a priori knowledge, filtering, a ruleset, heuristic, or other process). The “retriever” is used to accommodate the reality that it is presently cost prohibitive to apply the “reader” model(s) to the “full corpus”, so instead, a process is used to narrow down the set of content being considered by “retrieving” content with matching anchor/Boolean keywords to reduce application of a “reader” process to every snippet.

As an alternative approach to implementing this stage (i.e., use of retriever and reader functions), in addition to using Boolean connected keywords, recall of matching narratives can be improved by leveraging dense passage retrieval (DPR). This involves identifying semantically similar snippets to the Boolean keywords (based on a metric applied to an embedding or other representation), to a narrative description, or to other related information that doesn't contain the anchor keywords.

Using this alternative approach, the narrative matching process may continue to use Boolean keywords for the “retriever” step, but may also find additional, semantically similar snippets by performing the following steps or functions:
Generate embeddings for all (or if applicable, a subset) of the available snippets using a state-of-the-art embedding model (i.e., one of the top performing embedding models). This may be done as content is ingested, and snippets are generated;
At the “retrieval” stage of the processing, take a uniform sample of X snippets that match the Boolean keywords and find the Y most “similar” snippets to these in the embedding space;
   The process can improve on this approach by doing a more selective sampling of snippets that match anchor keywords and using different similarity thresholds or metrics;
Next, the process uses one of the two “flavors” of “NLP narratives” described below.

A first “flavor” is based on zero-shot-learning (ZSL) and/or use of a large language model (LLM). In another embodiment, a fine-tuned Pre-Trained Language Model (PLM) may be used.

For narratives that have a small enough set of anchor/Boolean keyword matches (an initial threshold will likely be ^{˜}50,000, but this is expected to increase over time) and require NLP, an embodiment can use one or more trained LLM to classify whether a snippet that contains the anchor/Boolean keywords is a match for the narrative.

The following are examples of options for implementing this process:
Zero-shot-learning—take the description of the narrative provided by the user and for each snippet that is a keyword match, prompt the LLM to label 1 if the snippet is a match given the narrative description and 0 otherwise (or other equivalent prompting strategy for the classification task). Consider all snippets labeled 1 to be matches;
Few-shot-learning—use the same approach as above but include examples of positive and negative matches in a prompt. These can be identified by:
   Having the user manually add examples;
   Having the user label a uniform set of examples;
   Having the user label results from the “zero-shot-learning” approach; or
   A combination of the above.

If it is desired to implement a fine-tuned Pre-Trained Language Model to identify narratives of interest or concern, then the following process may be used:
Generate labeled training data from a uniform sample of 100-300 snippets matching the Boolean keywords of a narrative by one of the following:
   Manually labeling whether they match the narrative (e.g., 1 if a match, 0 otherwise);
   Using a LLM with the approach outlined in the “ZSL/LLM” section above to label whether a snippet matches the narrative;
   If available, use a programmatic labeling technique to perform large scale labeling of a set of narratives;
Use this labeled data to fine-tune a pre-trained language model:
   This can be done using SetFit (https://huggingface.co/docs/setfit/en/index), but there are other approaches that may be used;
   This model is then deployed so that it can be used in “narrative scoring” as disclosed and/or described herein;
   Other small LLMs and fine-tuning methods may be used to improve the results.

The developed model may then be used for purposes of narrative scoring at one or more of the following points or stages:
Initial model activation-after the model is activated, it is used to identify all snippets in a corpus that match the narrative;
   In some cases, an additional limitation that the snippets must be from a post uploaded in the last 2 years (for example) may be applied as a cost management technique;
   Regular scoring updates—as new posts are scraped and new snippets are generated, the model is applied to the new snippets to determine if they match the narrative or match it closely enough.

The model may be used as described in the following to identify “narrative matches”:
Retriever—all anchor/Boolean keyword(s) matches are found from the appropriate set of snippets (either the full corpus and/or new snippets);
   If the narrative is “keyword only”, then consider the identified snippets to be narrative matches and stop the process;
Reader (optional)—if the narrative is a “NLP narrative”, use the model created in the process described to score the snippets identified in the “retriever” step;
   Apply a threshold value to the generated score to determine which snippets are considered matches and subjected to further processing.

In one embodiment, once a narrative is created, the described and/or disclosed system performs the following operations or functions:
Automatically discovers new channels/snippets across platforms the system supports. These are then compared (i.e., seeking a match) to the narrative;
Fetches snippets already in the data lake from previous narrative creation and compares these to the narrative; and
Updates models that determine the frequency at which channels that have already been “discovered” should have data ingested and updates the models that determine whether the processing should perform transcription, OCR, or image captioning from posts ingested from a given channel.

### Contextual Information About Channels

In addition to matching snippets to narratives (or vice-versa), embodiments may also operate to infer other information about channels represented by snippets in the data lake. There are a variety of ways this channel level information can be used; however, the following focuses on use cases associated with optimization of content ingestion. This represents an optimization of the process flow used to identify channels expected to contain content of interest or concern based on a desired narrative or narratives.

Non-limiting examples of types or categories of channel and the associated inferred or imputed channel and/or content characteristics include:
Communities
   A “community” in this context is a set of content creators (specifically, the channels associated with them) that create similar types of content and/or express similar beliefs. Content creators can be members of multiple communities, but for purposes of simplification and conservation of computational resources, embodiments may require that a significant portion (e.g., 30%) of a creator's posts “match” what is expected for a given community to be included;
At present (although it is expected this will increase over time), the disclosed and/or described platform/system supports ^{˜}40 communities and can add communities as customers/users show interest in new communities. The current communities roughly fit into two main categories:
   Political/cultural
   These are communities that discuss political and cultural issues (i.e., non-traditional political topics, such as “culture war” topics); The system has sourced definitions and labeled data for these communities from an open-source project: https://github.com/markledwich2/Recfluence;
      Examples of such communities are: Partisan Right, Partisan Left, Libertarian, or Socialist;
   Broad content categories
   These are content categories that exist on YouTube, and the disclosed system was used to obtain labeled data for these through scraping of YouTube channels. However, the categories are likely relevant to other platforms as well;
      Examples of such types of community are: Personal Finance, Sports, Food, Technology, Health, Fashion, or Physical Fitness.
The disclosed and/or described system imputes the “community” that a channel is a member of using one or more of the following approaches:
   Social network analysis
   For platforms in which the system can collect a sample of individual followers/subscribers' data, this data may be used to generate embeddings for channels. These embeddings are then used with labeled data and k-nearest neighbors to predict the community each channel is a member of;
      This may be performed using the method described in the article titled “Understanding YouTube Communities via Subscription-based Channel Embeddings”, /https://arxiv.org/pdf/2010.09892;
   Content classification
   For platforms for which the social network analysis data is not available or sufficient, the approach can use the titles and descriptions of posts to impute a community for the channel responsible for uploading the posts;
      Specifically, in one embodiment, and for each community, the following may be performed:
         Sample up to 1000 channels from the labeled dataset for the given community and 10 posts from each of these channels. Label titles/descriptions from this set of posts as “1”;
         Sample the equivalent number of channels/posts that are *not* in the community. Label titles/descriptions from this set of posts as “0”;
         Fine-tune a PLM (e.g., https://huggingface.co/google-bert/bert-base-uncased) on the set of labeled titles/descriptions from the previous step;
      For newly discovered channels for which posts have been ingested, apply the models from the previous steps to a sample of 10 titles/descriptions. If greater than 30% of these are classified as being in a given community, then label the channel as being in this community;
         Experiments (i.e., tests of samples) can be run to identify threshold values on a per community basis that have different precision/recall statistics than the default threshold value of 30%.

As non-limiting examples of possible uses of channel level information, consider the following:
Communities—This can be used to analyze which types of content creators are discussing a narrative of interest. For example, if a customer is an auto company tracking the narrative around “negative mentions of electric vehicles”, they might want to know how “partisan left” creators are discussing this vs. “partisan right” creators, etc.;
Location—an embodiment can be used to “predict” the country a channel is located in. This can be useful for analysis of narratives as well, for example, by indicating how certain narratives are being discussed in key markets.

### Threatening Content

Embodiments can generate labels for channels to help capture how threatening or concerning the content on these channels may be. Non-limiting examples of this capability may include:
Whether weapons are identified in a channel's content;
Whether a channel has generated hate speech in the past.
   These labels or characteristics may be used for purposes of optimizing content ingestion (e.g., by preferentially including or excluding content with such a label).

### Channel Discovery

With the preceding discussion as a foundation, the following describes how the disclosed and/or described approaches can overcome the challenges mentioned to help customers/users track content matching a narrative of interest. As noted, before the system/platform can ingest posts from a channel, generate snippets from these, and match them to narratives, it must first “discover” the channel. To discover channels not already found, the system/platform may implement one or more of the approaches described in the following on an ad-hoc or an ongoing basis.

### Chan2Vec and Public Follower/Following Data

In addition to using Chan2vec for channel classification, in some embodiments, it may be used for channel discovery. This is covered in greater detail in the previously mentioned article (“Understanding YouTube Communities via Subscription-based Channel Embeddings”, /https://arxiv.org/pdf/2010.09892).

As one non-limiting example, in the case of the YouTube platform, this method leverages the fact that a large percentage of users that comment on YouTube videos have publicly available subscription pages. These pages list which channels those users are subscribed to and that information may be used to identify other channels of possible interest (where each user is on average subscribed to 180 channels). This has proven to be an effective way to discover channels and on YouTube and has resulted in the discovery of over 180 million channels. A similar strategy can be used for other platforms that provide publicly available information on the channels a given commenter/user is following or is otherwise connected to.

### Cross Platform Links

Individuals frequently have channels on multiple platforms and reference their own channels/posts and those of other users across platforms. This has proven to be a useful way to discover channels.

### Channel Metadata/About Pages

Some channels contain “about” pages or have sections of a page that provide information on a channel. It's common for these to either contain explicit sections for linked channels or for users to share links to channels in a free form description. For example, a YouTube account may contain links to Facebook, Instagram, or X (formerly Twitter). An Instagram account may include a link to a “link tree” in the profile description, where the link tree contains a link to the account owner's podcast. In one embodiment, the disclosed and/or described system may use basic regular expressions or HTML parsing to extract these channels from profiles of channels that have been used as a source of ingested data.

### Post Metadata/Content

It is also common for post descriptions (or in some cases post images and transcripts) to contain links to other accounts or posts. In this situation, and similarly to the above, the disclosed system may use basic regular expressions or HTML parsing to extract these channels from profiles of channels that have been used as a source of ingested data. In cases where a post URL doesn't contain the account handle (such as YouTube video URLs), the system may scrape the post page and do additional HTML parsing to identify the channel.

### Explicitly Querying Twitter (X)

Similarly to the above, the disclosed system can leverage access to the Twitter (X) API to query for posts that contain links to channels of interest. To do this, the system may use the Boolean keywords for a set of narratives that are of interest and extend them to ensure they contain a URL. For example, the narrative (“climate change” OR “global warming”) would be extended to ((“climate change” OR “global warming”) AND “https://t.co*”). The system then uses a set of processing steps of the type described in the “Post Metadata/Content” section to extract channel information.

### Crawling Category Pages

Another approach that may be used to discover channels on a platform is a “category” page (such as that found for BitChute, Rumble, and Gab). For these, the system ingests the “category” page in the same way it ingests “channel feeds” (as disclosed and/or described herein), and new channels discovered through HTML parsing of these pages are added to the data lake.

### Crawling Hashtag Pages

Similarly, some platforms have pages that can be used to identify posts that contain a given “hashtag” (such as BitChute, TikTok, and Instagram). For these, the system uses the same approach as used for “Crawling Category Pages” but first identifies a set of hashtags to scrape.

In order to identify the most promising hashtags, the system may do the following:
Extract hashtags from all snippets and posts that have been matched to a narrative; and
Aggregate this data to identify the number of matches for each hashtag.

The system then scrapes posts using the top X most matched hashtags, where X is defined by the amount of computational (or other) resources being allocated to this function/operation on a given day (and hence may be subject to its own optimization process). The hashtag pages are scraped in the same way the system ingests “channel feeds” and new channels discovered through HTML parsing of these pages are added to the data lake.

In addition to (or instead of) the mentioned approaches, the following may be used:
The system (in some cases) may only scrape one “page” of results to limit compute costs. However, for some platforms, this can be improved by using a headless browser or other approach to paginate result pages and significantly increase the number of posts obtained/ingested from an individual hashtag;
The system can also optimize the set of hashtags being scraped. This can be done by developing a model that estimates the number of new relevant channels a given hashtag is likely to return and then selecting the set of X highest ROI hashtags based on this result.

### Using Platform Search/Google Search

Another option is to use the search functionality provided by a given platform or a 3rd party search engine (such as Google, or DuckDuckGo) to identify new posts. This is done by searching for the Boolean keywords of narratives and using the approaches disclosed and/or described herein to parse the results and discover new channels.

### 3rd Party Resources

In addition to the techniques disclosed and/or described herein, 3rd party resources that have their own techniques for identifying channels (such as BrightData or SocialBlade) may be used instead of (or in addition to) the techniques discussed. In some cases, data on specific channels on platforms may be purchased from these 3rd party resources to ensure “gaps” in the disclosed system's coverage are filled.

### Targeted Manual Searches

Many (if not all) of the approaches and techniques discussed herein are typically executed programmatically. However, in some cases, it may be advantageous to use manual efforts to discover channels. In these cases, a person may choose to do one of the following:
Perform their own research (such as through Google, an LLM, or other source) to identify promising channels. These channels can then be added to the data lake through a feature in an application (e.g., one termed a “watchlist” in some embodiments); or.
Use a similar approach to that used to identify potentially high value hashtags, followed by manual pagination using these to discover posts/channels, and save the raw HTML. The raw HTML may then be programmatically parsed to identify new channels, and these are then added to the data lake.

### Channel ROI Estimation

After identifying potential channels of interest for ingesting content, it is helpful and, in some cases, may be necessary to estimate the value that can be obtained from ingesting and processing content from a given channel. This information can be used as part of a system (with accompanying metrics, thresholds, heuristics, rules, or other form of decision process) that determines which set of channels to ingest content from based on consideration of one or more characteristics of the content extraction and processing flow (as is described in detail in the discussion of “Content Ingestion Optimization”). One benefit of performing channel ROI estimation (i.e., the expected return on investment of a set of resources) is being able to monitor and if needed, adjust computational (or other) resource usage based on the expected ROI for the content extraction and processing for a channel.

As a non-limiting example, Channel ROI may be implemented for YouTube and TikTok based on the following considerations:
Subscriber count;
   Channels discovered with greater than X subscribers are considered “high” priority to ensure the processing covers the most popular channels on a platform (regardless of the type of content they generate);
Community classification;
   Classify what community a channel is in after ingestion of a small amount of data on the channel (as few as 20 posts, or less) or using chan2vec if that is possible. If a channel is classified to be in the “Political/Cultural” community (or other relevant community), consider it more likely to be “high” priority for further extraction and processing of content;
Manually identified channels/watchlists;
   Channels that users or system employees manually add to watchlists may be considered “high” or higher priority.
      Given the above, TikTok and YouTube channels that do not meet the above criteria are considered “low” or lower priority. As an example, “high” or higher priority channels may have data ingested daily and “low” or lower priority channels may not have additional data ingested or only be checked periodically.

An example of a more comprehensive approach which operates to “predict” the indicated outcome(s) for ingesting content from a given channel is the following:
Number of narrative library matches;
   Target function—for channel X, predict the number of new snippets from channel X that will be matched to narratives in the system library (where this is a set of ^{˜}100 narratives made available to all customers/users) if data for channel X is ingested at time T2 and the previous time data was ingested was T1;
   The “target function” describes the thing the system is trying to predict (i.e., how many new snippets one will find for channel X that match a narrative in the library if the system ingests and processes content from it);
   A baseline heuristic to estimate the expected number of matches and make the “prediction” is given by (average number of matched snippets per day)*(days since last scrape/ingestion);
Number of overall narrative matches;
   Target function/baseline heuristic is same approach as for “Number of narrative library matches” but instead is focused on all narratives (including those created by customers). Note that this second micro score (and associated heuristic) is focused on all narratives in the system (i.e. both narratives in the library and user defined narratives) while the first is only interested in narratives in the library;
Number of overall snippets;
   Target function—for channel X, predict the number of new snippets from channel X that will be found/generated if data for channel X is ingested at time T2 and the previous time data was ingested was T1;
   A baseline heuristic to estimate this value is given by (average number of overall snippets per day)*(days since last scrape/ingestion).

Each of these “predicted” numbers (i.e., narrative library match, overall match, overall snippets) is termed a “micro score” herein.

For a given channel, the disclosed and/or described system will then have at least some of the following information, which can be used as inputs to a model trained to predict each of the micro scores (or to assemble a set of training and testing data):
If content has been ingested at some point;
   Information on previous snippets generated from the channel;
   Information on what narratives the snippets have been matched to;
Embeddings for a set of channels;
   These are generated such that channels closer in the embedding space are expected to be more likely to generate similar types of content or have a similar audience;
   For platforms in which the system has sufficient subscriber/commenter information for channels, one may use the Chan2vec approach described herein;
   For other channels, one can use a metadata-based approach to generate the channel embedding;
      This involves sampling 100 snippets from a channel (or a larger number that is found to produce better results), generating embeddings for these using a state-of-the-art sentence embedding model (i.e., one of the better performing embedding models), take the average of these embeddings, and use this as the embedding for the channel;
Channel discovery information, such as
   Cross platform links;
   Hashtags;
   Results of a Twitter/X search;
   Results of a Google/platform originated search.

Next, generate a training dataset as follows (as a non-limiting example):
Each instance of the training data is represented as a triplet of the form (channel, current ingestion date, last ingestion date);
Sample a set of instances as follows:
   Randomly sample 100,000 channels;
   Randomly sample 5 dates from the last year for each channel. These will be treated as the “current ingestion date”;
   For each channel's “current ingestion” date, randomly sample a “last ingestion” date that is 1-30 days prior to the “current ingestion” date;
Generate data point labels as follows:
   For each triplet, query the data lake to determine each “micro score” value for the given channel for the period between the current and last ingestion dates;
   If the channel does not have complete information during this period (e.g., due to ingestion constraints, there may not be complete information on the posts uploaded during the period), then discard the instance;
Generate the following features:
   Number of days since last ingestion;
   Micro score baseline (as defined for each micro score above);
      In one embodiment, the system may randomly assign Y percent of these to be “null” to have a set of instances that represent newly discovered channels;
   Min/max/median/average micro score baseline for the X most similar channels (typically limited to channels that have a post ingestion history) found using channel embeddings;
      “Experiments”/simulations can be run to identify an optimal value of X. As an example, a value of 20 has been found to be an effective number for many cases;
      The system may randomly assign the same Y percent of these as above to be “null” for channels that require snippet embeddings to generate channel embeddings;
   Min/max/median/average micro score baseline for channels linked to a given channel through “cross platform links”;
   Number of hashtag page searches that the channel occurred in;
   Number of Twitter (X) searches that the channel occurred in;
   Number of Google/platform searches that the channel occurred in.
      For each micro score, the approach then trains a XGBoost (or similar) model using the described dataset. These models are then used to generate channel ROI predictions daily (or at a more, or less frequent interval based on computational cost constraints and channel ingestion frequency). The channel ROI micro score estimates may then be used to prioritize the channels to determine which to ingest data from or in which order to ingest data.

### Post OCR, Image Captioning and Transcription ROI Estimation

In addition to determining which channels to ingest data from on a regular basis, for some platforms it may be beneficial to also determine which individual posts from channels to generate transcripts for (in the case of video and audio content) or to generate image captions/extract text using OCR (in the case of image and video content). As with certain of the other processes or techniques disclosed and/or described herein, this may assist in allocating the use of computational resources and deciding which channels, sub-channels, or content to extract/ingest and process.

As a non-limiting example, a process for deciding which channels or sub-channels for which to transcribe content may be performed as follows:
Transcribe content for the following platforms (YouTube is a unique exception in that it's a video platform from which transcripts can be obtained directly);
   TikTok, BitChute, Rumble, Podcasts;
      For TikTok, use the following heuristic;
      If a given post is from a channel that has 2 previous title/description narrative matches and the post has over X views, transcribe it. Other posts are not transcribed;
      For BitChute, Rumble, and Podcasts transcribe all content with over Y views (in the case of podcasts, the system can use “downloads”, obtained using a service called Rephonic to estimate this value);
         The X and Y threshold values may be varied, tested, and adjusted to meet a monthly target spend on computational or other resources for transcription operations.

As a non-limiting example, deciding which channels or sub-channels for which to apply OCR (optical character recognition) to ingested content may be performed as follows:
Use closed source OCR models (such as Azure Vision) to extract text from images; This may be done for all images ingested from Gab and Instagram (as examples); This is an initial heuristic that may be refined and focused, applied to other platforms, limited when applied to some platforms, etc.

As a non-limiting example, deciding which channels or sub-channels for which to apply image captioning may be performed as follows:
Use closed source multimodal LLMs (such as GPT4) to generate descriptions of images;
   This may be done for all images ingested from Gab and Instagram (as examples); This is an initial heuristic that may be refined and focused, applied to other platforms, limited when applied to some platforms, etc.

As mentioned, the allocation and use of computational or other resources can become a concern as the processes disclosed and/or described herein are scaled upwards to correspond to an increased number of channels discovered and content ingested across multiple platforms. To limit the amount (i.e., cost) of computational resources and ensure the ROI is as high as practical (or feasible given a strict resource allocation) for transcription, OCR, and image captioning, the system may construct and use a model to predict the likelihood of a narrative match prior to applying each of the three “enrichment” functions (i.e., transcription, OCR, and image captioning).

These models (one each for transcription, OCR, and image captioning) may be trained as follows:
Initial training dataset;
   Apply a given model (i.e., transcription, OCR, or image captioning) to 100,000 uniformly sampled posts from the current corpus and generate snippets from these;
   Apply narrative scoring (matching) to the snippets;
   If one or more snippets from a post are matched to one or more narratives, then label the post “1”, otherwise label it “0”;
Initial model training;
   Use the training data to fine-tune a PLM (a pre-trained language model such as BERT-base-uncased) with the input being post metadata (e.g., title and description) concatenated to the channel description;
Regular scoring;
   For each new post that is ingested, use one or more of these models to “predict” whether the post will generate narrative matches from application of transcription, OCR, or image captioning;
   For posts with a probability >=0.5 of generating a narrative match (or other threshold value that generates desired precision/recall values), apply the appropriate model;
Model retraining;
   On a regular basis (weekly or monthly, as examples), sample 1,000 new posts;
   Apply all three models to these and generate new snippets;
   Follow the last two steps of the “Initial training dataset creation” (scoring and assigning a value of 1 or 0) followed by the step(s) of “Initial model training”;
   Use the newly trained models for new snippets that are ingested.

If desired and practical, the described approach may be improved by implementation of one or more of the following changes:
Use of a regression model instead of a classification model;
Stack a Multilayer perceptron (MLP) onto the PLM and add channel aggregate features, such as one or more of:
   Percentage of titles/descriptions that have narrative matches;
   Number of posts that have been transcribed;
   Number of narrative matches from posts.
      A benefit is that the model would generate a more accurate prediction for a given post by both combining results from the fine-tuned PLM prediction which leverages post title/description information and the channel level information which it wouldn't have access to otherwise.

### Content Ingestion Optimization

The disclosed and/or described system is able to leverage channel discovery and channel ROI estimation to significantly increase the number of narrative matches found across a variety of platforms for a fixed ingestion “cost” (i.e., computational, or other form of resource). This provides a solution to one of the primary challenges in monitoring social network posts for content of interest or concern.

In the absence of applying the advanced approaches to channel discovery disclosed and/or described herein, a limited number of platforms or sources (such as TikTok and YouTube) may be the only ones for which there is a need to limit the daily content ingestion to a subset of the high (er) priority channels. However, as the channel discovery process is scaled up, a more comprehensive approach to optimizing content ingestion may need to be implemented to prevent computational costs (or other resources) from increasing to a prohibitive level.

One such comprehensive approach involves using the “micro score” estimates described herein for all discovered channels to identify a more optimal set of channels from which to extract and process posts. This may be implemented using an “explore and exploit” reinforcement learning strategy. To do this, the disclosed system creates a set of channels that will have data ingested daily by performing the following process:
Add all X channels that business logic for a user requires;
   This can vary based on the organization. In one example, this consists of all channels that have been added to “watchlists” by a user or internally by an employee;
   This may also include the “head” channels for a platform, such as the top 100,000 most popular ones based on follower count;
      This can be important to ensure the system doesn't miss a valuable mention from a head channel even if that channel is unlikely to create content that matches a narrative of interest;
Exploit—add the Y channels with the highest predicted ROI;
   This includes the Y1 channels with the highest estimated “Number of narrative library matches”;
   Add the Y2 channels with the highest estimated “Number of overall narrative matches”;
   There may be some overlap between the X and Y channels, but it is not required (i.e., it is the union of X and Y that is utilized);
Explore-add the Z channels with the highest predicted ROI that aren't in X or Y and have one of the following characteristics;
   Z1=the system has not ingested post data for them yet;
   Z2=the system has not ingested post data in over 90 days (or other more optimal threshold).
      In one implementation, a hard cap on the sum (X+Y+Z) may be applied to ensure the number of overall channels is at a level where data ingestion can meet required service level agreements (SLAs) and keep computational or other resource costs within a desired range.

Depending on the cost determination for ingesting content from a platform, it may be desirable to normalize the channel ROI micro scores using the “Number of overall snippets” value. Further, there is some flexibility for setting X, Y, and Z. One can begin by picking “reasonable” values for these based on a business goal but in the long term they are parameters that can be optimized using machine learning techniques. Optimization can be used to maximize narrative matches while adjusting for the cost associated with ingesting content from each platform and the value (e.g., to a user or investigator) associated with each platform.

### Surfacing Content in a Web Application

In some embodiments, the assignee of the present disclosure uses a SaaS platform to deliver services and applications, and a primary way users access the system/platform capabilities to develop insights is through a web application. In some embodiments, such an application also enables performing historical analysis of narratives over a specific time period. For example, a user can perform trend analysis as well as review specific snippets that are matched to a narrative. The web application may also enable a user to filter and analyze the data using specific labels or characteristics; these may include community information, threatening language, sentiment, name entity recognition, or specific enrichments (OCR, image captioning, audio transcription as examples), as non-limiting examples of the application's functional capabilities.

### Example Use Cases

In addition to those mentioned, the disclosed and/or described system or platform capabilities enable users to perform the following functions or operations:
Identify and track content on social media platforms discussing a company's brand, executives, or products that have the potential to generate reputational damage, physical threats, or other types of risks or opportunities (such as by identifying potentially harmful misinformation or disinformation); and
Better enable an organization to mitigate risks or take advantage of opportunities by recognizing an early indication of the growth of a discussion or concern and obtain a comprehensive view into the communities and parts of the information ecosystem that the discussion or concern is propagating into or through. This may be useful in identifying future sources of concern or the growth of an issue that may need to be addressed or can be used to an advantage.

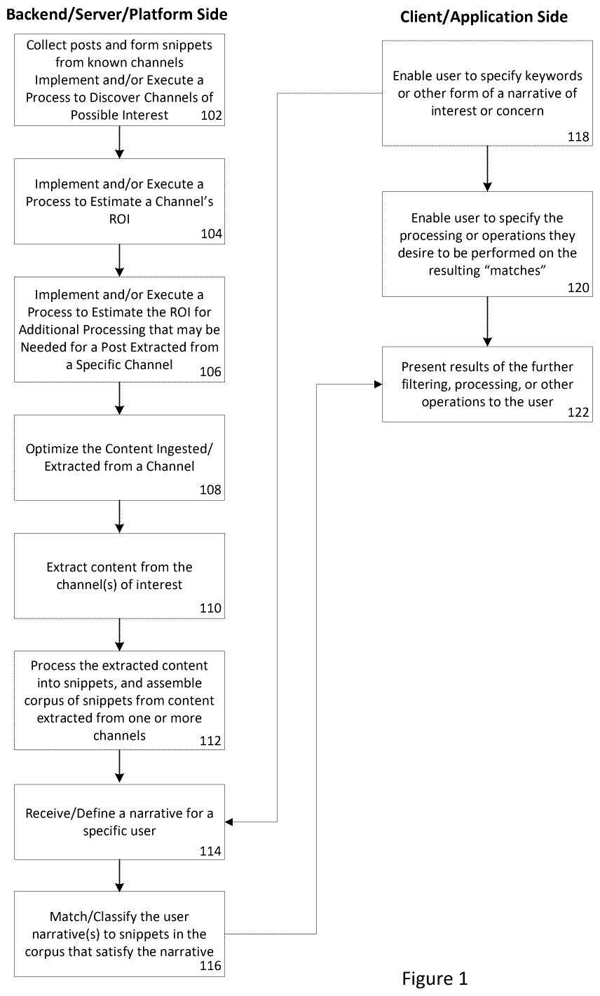

FIG. 1 is a flow diagram illustrating a set of processes, operations, or functions that may be used to enable monitoring of social network and social media posts to assist in identifying posted video, audio, or textual content that may be of interest or concern to a specific entity, in accordance with an embodiment of the disclosure. As shown in the figure, in one embodiment, the disclosed and/or described approach may include one or more of the following steps, stages, operations, functions, processes, or methods:

### Backend/Server/Platform Side

Identify and collect posts and form snippets from known channels for later use in comparing to a narrative (as suggested by step or stage 102);
   All snippets that have been ingested remain in a data lake;
   After identifying a channel, the system ingests a variety of posts from it and generates snippets from these posts;
      This initial data may be used to estimate a channel's ROI (which can be used to determine whether to continue ingesting data from the channel going forward and if so, at what cadence);
   One or more examples of “business logic” or rules may be used to identify channels for extraction of content based on follower count, subject matter, or other indication of potential relevance to one or more narratives;
Implement and/or Execute a Process to Discover Channels of Possible Interest (as suggested by step or stage 102);
   Use one or more of contextual data, links, follower/following data, channel metadata, post metadata, crawling/scraping of a webpage, performing a keyword search or other form of search;
Implement and/or Execute a Process to Estimate a Channel's ROI (return on investment) for each of the discovered channels (as suggested by step or stage 104);
   Where the ROI is a measure that may be used to monitor and if needed, control computational resource (or other resource) usage based on the expected ROI associated with monitoring and/or extracting content from a specific channel;
   If desired, generate/calculate one or more of the described micro scores to assist in calculating or estimating the ROI, wherein a micro score represents a metric indicative of one or more of:
      Number of narrative library matches;
   In one embodiment, this “library” is a collection of narratives created internally by the assignee that are believed to be of interest to a large number of customers (for example, for corporate communications teams, there's likely to be interest in boycotts, inflation, executive compensation, and legal issues, as example topics of discussion, so a narrative for each of these topics can be created and provided to users/customers);
      Number of overall narrative matches;
      Number of overall snippets in a corpus or subset of the corpus;
   Train a ML model to predict the ROI for a channel using the generated/calculated data (such as the micro scores, as one example);
   In one embodiment, the micro scores may be combined to create a composite score and the composite score used to prioritize which channels to ingest data from. However, the weighting for each micro score may involve “business logic” and would be company/user dependent (i.e., some companies may want to prioritize matches for their own “library of narratives” over customer narratives or vice versa);
      The composite score generated from the micro scores is not needed for purposes of training the ROI prediction model as each micro score may be generated/predicted independently by a separate model;
Implement and/or Execute a Process to Estimate the ROI of Additional Processing that may be Needed for a Post Extracted from a Specific Channel (in one embodiment, this stage estimates the cost of processing as well as a likelihood of generating narrative matches) (as suggested by step or stage 106). In some embodiments, this may involve one or more of the following processes;
   Optical Character Recognition (OCR);
   Image Captioning;
   Transcription;
   Training a ML model or models to predict the amount or extent one or more of these processing operations is expected (predicted) to be needed;
Optimize the Content Ingested/Extracted from a Channel (as suggested by step or stage 108). This “optimization” process may be based on consideration of one or more factors or use of one or more techniques, including but not limited to;
   Based on the determined micro scores applicable for that channel; and/or
   Based on an “explore and exploit” approach as defined in one non-limiting example by;
      Add all X channels that business logic for a user requires;
      Exploit-add the Y channels with the highest predicted ROI;
      Explore-add the Z channels with the highest predicted ROI that aren't in X or Y and have one of the following limitations;
         Z1=the system has not ingested post data for them yet;
         Z2=the system has not ingested post data in over 90 days (or other more optimal threshold);
Extract content from the channel(s) or sub-channels identified as having a sufficient ROI to justify processing and resource usage (as suggested by step or stage 110);
   Although computational or processing usage is typically considered the “resource” of concern, others may be considered when deciding which channels or sub-channels to extract content from;
Process the extracted content into snippets, wherein a “snippet” is a slice or section (up to approximately a paragraph in length in some embodiments) of a “post” that is more convenient for purposes of being evaluated and reviewed (as suggested by step or stage 112). One or more of the following can be used as sources to identify and/or be part of a snippet formed from a post:
   Post title/description/hashtags;
   Transcripts from video and/or audio content; and
   Text contained in images (which may be determined using OCR or other technique);
Assemble a Corpus of Snippets from the Content Extracted from One or More Channels (as suggested by step or stage 112);
Receive/Define a narrative for a specific user, wherein a narrative consists of a “model” or “definition” that is used to determine whether a given “snippet”, post, or segment of content is a “match” for the given narrative (i.e., a narrative is a way of defining one or more characteristics of posted content/snippets being sought for purposes of further processing and evaluation) (as suggested by step or stage 114). As non-limiting examples, a narrative may be defined:
   Using Boolean operator connected keywords; and/or
   Using an NLP technique or model;
   In one example, a Boolean combination could be used initially, followed by forming a prompt for an LLM to determine if a snippet is discussing the desired topic and not one with similar or the same terms (such as a name that is also used to refer to a company or a company name that is the same or similar to a person of interest);
Match/Classify the user narrative(s) to one or more snippets in the corpus that satisfy (i.e., “match”) the narrative (as suggested by step or stage 116);
Here, matching is based on a comparison between a narrative and a snippet, typically with reference to a similarity metric;
Non-limiting examples of such a comparison or matching technique include one or more of keyword matching, semantic similarity (based on generating embeddings and performing a comparison or grouping of embeddings), or other functionally similar technique.

### Client/Application Side.

Enable user to specify keywords or other form of a narrative that represents their interest or concern (as suggested by step or stage 118);
   In one embodiment, a narrative may be generated using a generative technique that receives a prompt and generates several sentences that describe a situation of concern or provides a list of keywords or related topics;
Enable user to specify the processing or operations they desire to be performed on the resulting “matches” between the specified keywords or other form of narrative and content found posted to a channel (i.e., snippets derived from content posted to a channel) (as suggested by step or stage 120). Non-limiting examples of such processing include;
   Trend analysis (number of posts/snippets matching narrative over time, or other countable measure);
   Prediction or indication of a risk to user's interests (where these may include safety, brand, reputation, misinformation, disinformation, or other concern or interest);
   Filtering and analysis or evaluation (e.g., categorize, label, evaluate risk or other characteristic) the matches and related data and if desired, apply one or more of the categories of community information or threatening language, determine sentiment or use a process for name entity recognition, as non-limiting examples;
   As one example, this could be used to assist a user/customer to better understand which entities or topics are receiving a greater share of the mentions in content;
Present results of the further filtering, processing, or other operations to the user; In a suitable or specified form, such as one or more of a table, listing, graph, set of links to content, examples of most relevant snippets and indication of match (or measure of confidence in a match) to specific narrative(s) or categories (as suggested by step or stage 122). In one embodiment, these results may be presented on a client device or provided as a document on the server or platform that can be accessed using the client device.

In one embodiment, the results of the operations to identify channels and extract posts of interest (based on channel characteristics, channel ROI, or other aspect), convert the extracted posts into snippets, and compare the snippets to narratives of concern or interest may be used to automatically trigger or initiate an action or event. As non-limiting examples:
A snippet involving a threat to a CEO threat mayl result in the security team being notified so that they can take action;
A spike in product issues being mentioned can be surfaced with the appropriate product team to resolve the issue(s); or
A spike in calls-to-boycott can result in a corporate communication team releasing a statement to counter that activity.

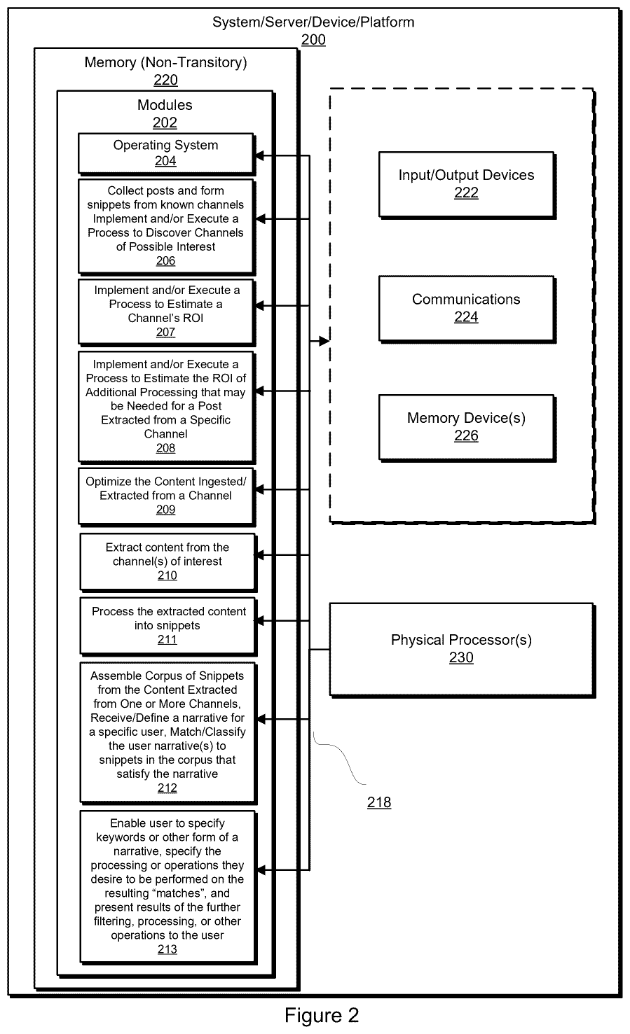

FIG. 2 is a diagram illustrating elements or components that may be present in a computing device or other form of processor configured to implement a method, process, function, or operation in accordance with an embodiment of the system and methods disclosed and/or described herein. As shown in the figure and as mentioned, in some embodiments, the disclosed system and methods may be implemented in the form of an apparatus that includes an electronic processing element and a set of computer-executable instructions. The executable instructions may be stored in (or on) a non-transitory memory or data storage element and be part of a software application arranged into a software architecture.

In general, an embodiment may be implemented using a set of software instructions that are executed by a suitably programmed processing element (such as a GPU, CPU, TPU, QPU, state machine, microprocessor, processor, co-processor, or controller, as non-limiting examples). In a complex application or system such instructions are typically arranged into “modules” or “submodules” with each such module or submodule typically performing a specific task, process, function, or operation when the corresponding instructions are executed. The entire set of modules and submodules may be controlled or coordinated in their operation by an operating system (OS) or other form of organizational structure.

Each application module or submodule may correspond to a particular function, method, process, or operation that is implemented by execution of the instructions contained in the module or submodule. Such function, method, process, or operation may include those used to implement one or more aspects of the disclosed and/or described systems and methods.

The application modules and/or submodules may include a computer-executable code or set of instructions (e.g., as would be executed by a suitably programmed processor, microprocessor, co-processor, or CPU, as non-limiting examples), such as computer-executable code corresponding to a programming language. For example, programming language source code may be compiled into computer-executable code. Alternatively, or in addition, the programming language may be an interpreted programming language such as a scripting language.

Modules (or submodules) may contain one or more sets of instructions for performing a method, process, operation, or function described with reference to the Figures, and the description or disclosure of the methods, processes, operations, and functions provided in the specification. These modules may include those illustrated but may also include a greater number or fewer number than those illustrated.

A module or submodule may contain instructions that are executed by a processor contained in more than one of a server, client device, apparatus, network element, system, platform, or other component. In some embodiments, a plurality of electronic processors, with each being part of a separate device, apparatus, server, network element, platform, or system may be responsible for executing all or a portion of the software instructions contained in an illustrated module or submodule. Thus, although FIG. 2 illustrates a set of modules which taken together perform multiple functions or operations, these functions or operations may be performed by different devices, apparatuses, or system elements, with certain of the modules (or instructions contained in those modules) being associated with a function or operation performed by those devices, apparatuses, or system elements.

As shown in FIG. 2, element or component 200 may represent a server or other form of computing or data processing system, platform, apparatus, or device. Modules 202 each contain a set of executable instructions, where when the set of instructions is executed by a suitable electronic processor or processors (such as that indicated in the figure by “Physical Processor(s) 230”), system (or server, platform, apparatus, or device) 200 operates to perform a specific process, operation, function, or method.

Modules 202 are stored in a non-transitory memory 220, which typically includes Operating System module 204 that contains instructions used (among other functions) to access and control the execution of the instructions contained in other modules. The modules 202 stored in memory 220 are accessed for purposes of transferring data and executing instructions by use of a “bus” or communications line 218, which also serves to permit processor(s) 230 to communicate with the modules for purposes of accessing and executing a set of instructions.

Bus or communications line 218 also permits processor(s) 230 to interact with other elements of system 200, such as input or output devices 222, communications elements 224 for exchanging data and information with devices external to system 200, and additional memory devices 226. Each module or sub-module may contain a set of computer-executable instructions that when executed by a programmed processor or processors cause the processor or processors (or a device or devices in which they are contained) to perform a specific function, method, process, or operation.

With reference to FIG. 2, in some embodiments, the implemented steps, stages, elements, components, functions, methods, processes, or operations may include those used to perform one or more aspects of the disclosed and/or described system and methods, such as to:
Collect posts and form snippets from known channels (as suggested by module 206);
Implement and/or Execute a Process to Discover Channels of Possible Interest (as suggested by module 206);
Implement and/or Execute a Process to Estimate a Channel's ROI (as suggested by module 207);
Implement and/or Execute a Process to Estimate the ROI for Additional Processing that may be Needed for a Post Extracted from a Specific Channel (as suggested by module 208);
Optimize the Content Ingested/Extracted from a Channel (as suggested by module 209);
Extract content (such as a post or posts) from the channel(s) of interest (as suggested by module 210);
Process the extracted content into snippets (as suggested by module 211);
Assemble Corpus of Snippets from the Content Extracted from One or More Channels, Receive/Define a narrative for a specific user, Match/Classify the user narrative(s) to snippets in the corpus that satisfy (match) the narrative (as suggested by module 212);
Enable user to specify keywords or other form of a narrative, specify the processing or operations they desire to be performed on the resulting “matches”, and present results of the further filtering, processing, or other operations to the user (as suggested by module 213);
   In some embodiments, portions of this operation may be performed prior to the matching operation performed by execution of instructions or code in another module.

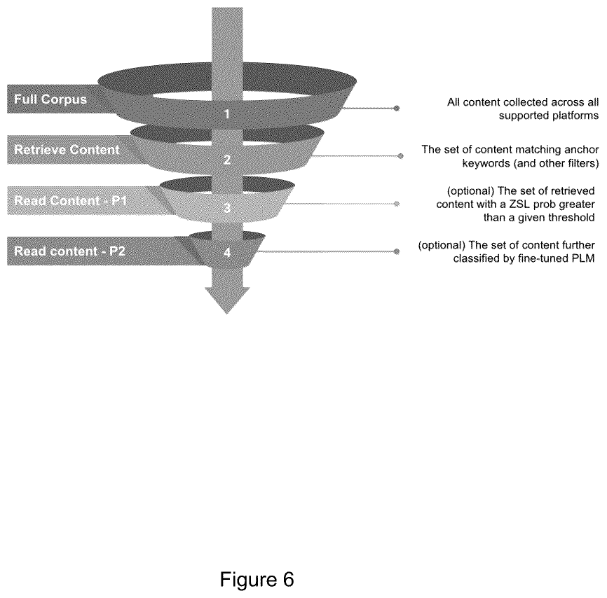

FIG. 6 is an illustration of an example process by which snippets from the full corpus of data are matched to a specific narrative. As shown in the figure, this process first occurs by identifying snippets through a retrieval step (such as using Boolean keywords or dense passage retrieval with semantic embeddings). These snippets are then optionally filtered further through a zero-shot-learning (ZSL) NLP approach or a fine-tuned PLM (pre-trained language model) NLP approach.

As mentioned, in some embodiments, the systems and methods disclosed and/or described herein may provide services through a Software-as-a-Service (Saas) or multi-tenant platform. The platform provides access to multiple entities, each with a separate account and associated data storage. Each account may correspond to a specific social media platform, a specific channel or sub-channel on that platform, a specific narrative, an entity interested in identifying and understanding specific posted content on a specific platform or platforms, a publisher of content, a brand, a governmental agency, a company, or an organization, as non-limiting examples. Each account may access one or more services, a set of which are instantiated in their account, and which implement one or more of the methods or functions described herein.

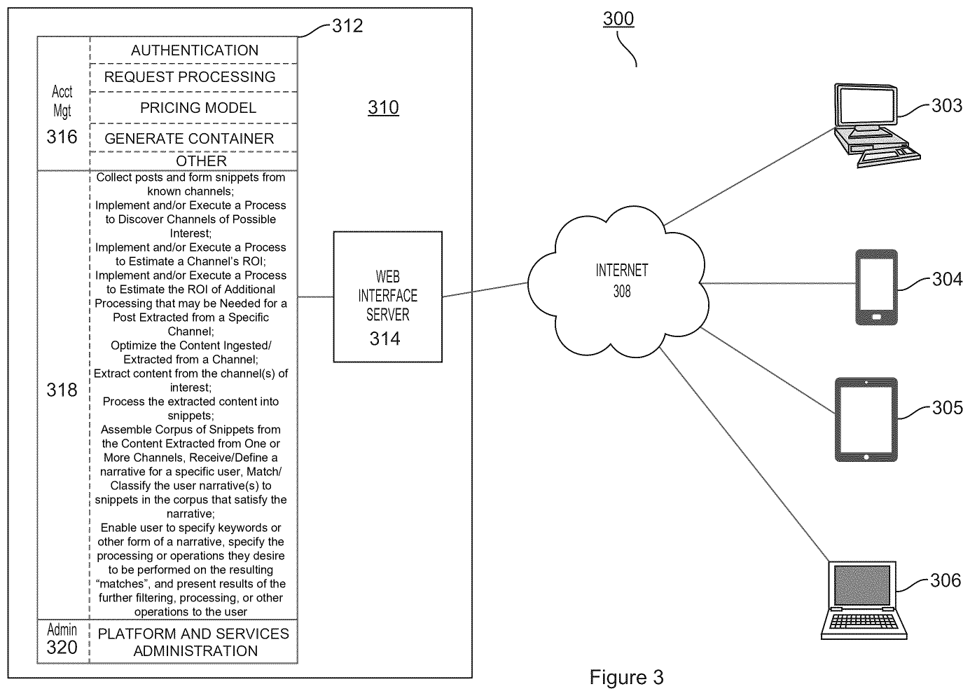

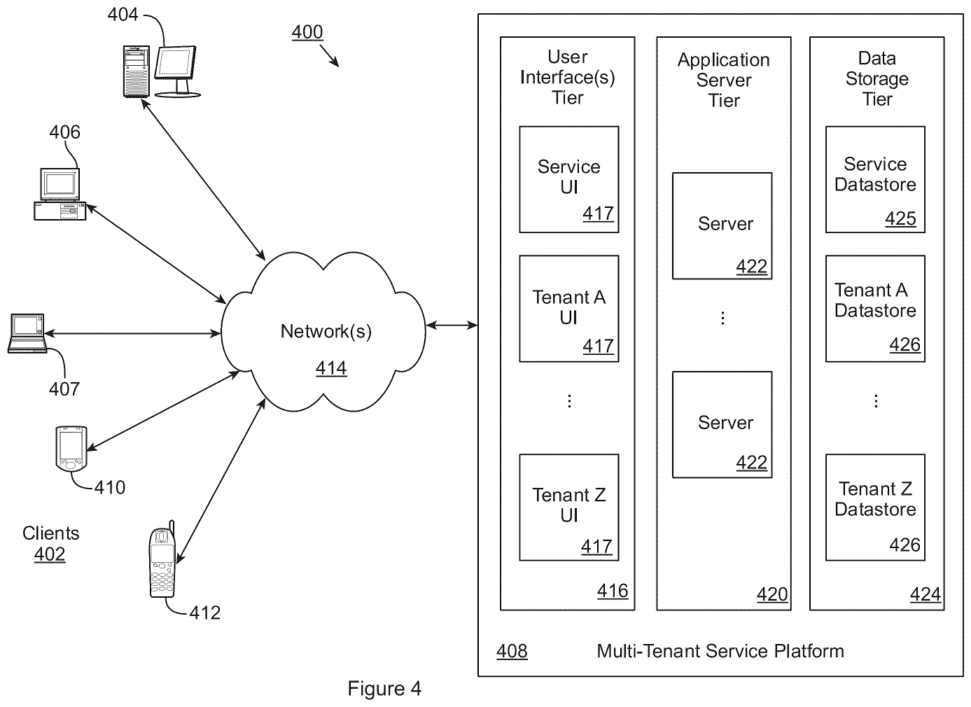

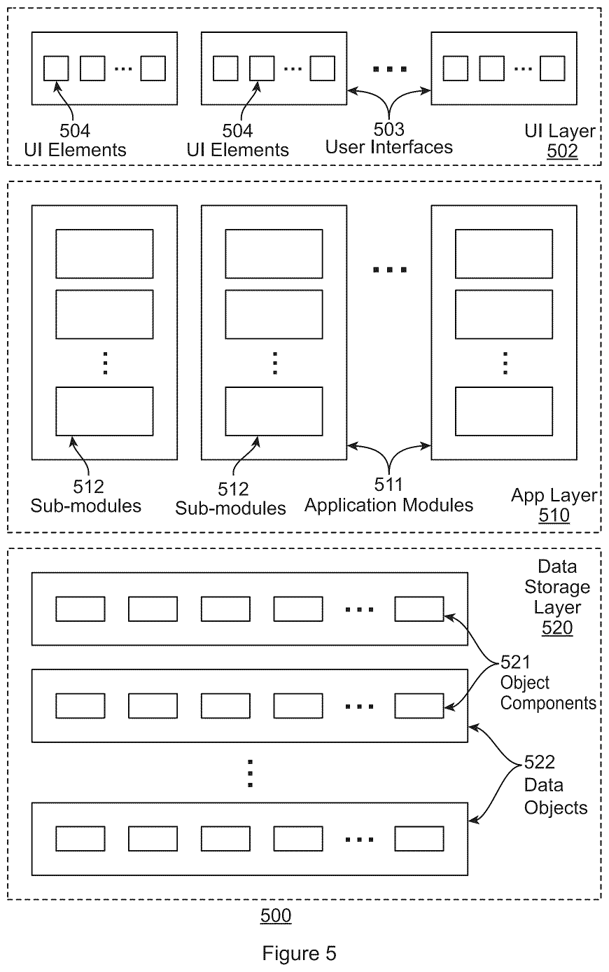

FIGS. 3-5 are diagrams illustrating an example architecture for a multi-tenant or SaaS platform that may be used in implementing an embodiment of the systems and methods disclosed and/or described herein. FIG. 3 is a diagram illustrating a SaaS system in which an embodiment of the disclosure may be implemented. FIG. 4 is a diagram illustrating elements or components of an example operating environment in which an embodiment of the disclosure may be implemented. FIG. 5 is a diagram illustrating additional details of the elements or components of the multi-tenant distributed computing service platform of FIG. 4, in which an embodiment of the disclosure may be implemented.

In some embodiments, the system or service(s) disclosed and/or described herein may be implemented as micro-services, processes, workflows, or functions performed in response to requests. The micro-services, processes, workflows, or functions may be performed by a server, data processing element, platform, or system. In some embodiments, the services may be provided by a service platform located “in the cloud”. In such embodiments, the platform is accessible through APIs and SDKs.

Services and functionality of the disclosed system architecture and associated processing may be provided as micro-services within the platform for each of multiple users or companies. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide services and functionality for identifying posted content that satisfies one or more narratives, as disclosed and/or described herein.

Although in some embodiments, a platform or system of the type illustrated in FIGS. 3-5 may be operated by a 3rd party provider, in other embodiments, the platform may be operated by a provider and a different entity may provide applications or services for users through the platform.

FIG. 3 is a diagram illustrating a system 300 in which an embodiment of the disclosure may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, or organizations, as non-limiting examples. In general, a client device having access to the Internet may be used to provide a request for a service or access to an application. Users interface with the service platform across the Internet 308 or another suitable communications network or combination of networks. Non-limiting examples of suitable client devices include desktop computers 303, smartphones 304, tablet computers 305, or laptop computers 306.

System 310, which may be hosted by a third party, may include a set of services 312 and a web interface server 314, coupled as shown in FIG. 3. Either or both of services 312 and the web interface server 314 may be implemented on one or more different hardware systems and components, even though represented as singular units in FIG. 3.

In some embodiments, the set of applications or services available to a user through the platform may include one or more that perform the functions, operations, and methods disclosed and/or described herein. As examples, in some embodiments, the set of applications, functions, operations, processes, or services made available through the platform or system 310 as one of services 312 may include:
account management services 316, such as
   a process or service to authenticate a person or entity requesting an evaluation of the social network posts or content related to a specific term, brand, interest, or other aspect (such as credentials, proof of purchase, or verification that the customer has been authorized by a company to use the services provided by the platform);
   a process or service to receive a request for matching/comparing a narrative to a set of snippets generated from posts or other social network content;
   an optional process or service to generate a price for the requested service or a charge against a service contract;
   a process or service to generate a container or instantiation of the requested processes for a user/customer, where the instantiation may be customized for a particular user or company; and
   other forms of account management services;
a set of processes or services 318 for (among other functions) optimizing the resources used to identify channels and extract posts of interest (based on channel characteristics, channel ROI, or other aspect), convert the extracted posts into snippets, and compare the snippets to narratives of concern or interest, such as a process or service to:
   Collect posts and form snippets from known channels;
   Implement and/or Execute a Process to Discover Channels of Possible Interest;
   Implement and/or Execute a Process to Estimate a Channel's ROI;
   Implement and/or Execute a Process to Estimate the ROI of Additional Processing that may be Needed for a Post Extracted from a Specific Channel;
   Optimize the Content Ingested/Extracted from a Channel;
   Extract content (such as a post or posts) from the channel(s) of interest;
   Process the extracted content into snippets;
   Assemble Corpus of Snippets from the Content Extracted from One or More Channels, Receive/Define a narrative for a specific user, Match/Classify the user narrative(s) to snippets in the corpus that satisfy (match) the narrative;
   Enable user to specify keywords or other form of a narrative, specify the processing or operations they desire to be performed on the resulting “matches”, and present results of the further filtering, processing, or other operations to the user;
administrative services 320, such as
   a process or services to enable the provider of the services and/or the platform to administer and configure the processes and services provided to users.

The platform or system shown in FIG. 3 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server (as non-limiting examples).

FIG. 4 is a diagram illustrating elements or components of an example operating environment 400 in which an embodiment of the disclosure may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented or executed at least in part by one or more of the computing devices.

Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components (e.g., one or more electronic processors, central processing units (CPU), or controllers). Examples of suitable networks 414 include networks utilizing wired and/or wireless communication technologies and networks operating in accordance with a suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, or causing the execution of specific data processing operations, as non-limiting examples.

Each application server or processing tier 422 shown in the figure may be implemented with a set of computers and/or components including computer servers and processors, and may perform various functions, methods, processes, or operations as determined by the execution of a software application or set of computer-executable instructions. The data storage tier 424 may include one or more data stores, which may include a Service Data store 425 and one or more Tenant Data stores 426. Data stores may be implemented with a suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify information or a request for services.

The platform resident functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than building and maintaining such a platform or system themselves, a business may utilize a platform or system provided by a third party. A third party (such as the assignee) may implement a business system/platform as described in the context of a multi-tenant platform, where individual instantiations of a business' data processing workflow (such as the data processing disclosed and/or described herein) are provided to users, with each user (e.g., business, company, organization, or other entity) representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users or customers.

FIG. 5 is a diagram illustrating additional details of the elements or components of the multi-tenant distributed computing service platform of FIG. 4, in which an embodiment of the disclosure may be implemented. In general, an embodiment may be implemented using a set of software instructions that are executed by a suitably programmed processing element (such as a CPU, microprocessor, processor, controller, or computing device). In a complex system such instructions are typically arranged into “modules” with each such module performing a specific task, process, function, or operation. The entire set of modules may be controlled or coordinated in their operation by an operating system (OS) or other form of organizational structure.

The example architecture 500 of a multi-tenant distributed computing service platform illustrated in FIG. 5 includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture.

Non-limiting examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more associated sub-modules 512. Each application module 511 or sub-module 512 may correspond to a function, method, process, or operation that is implemented by execution (in whole or in part) of the computer-executable instructions contained in the module or sub-module (e.g., a function or process related to providing data processing and other services to a user of the platform). Such function, method, process, or operation may include those used to implement one or more aspects of the disclosed and/or described system and methods, such as for one or more of the processes or functions disclosed and/or described with reference to the specification and Figures:
Collect posts and form snippets from known channels;
Implement and/or Execute a Process to Discover Channels of Possible Interest;
Implement and/or Execute a Process to Estimate a Channel's ROI;
Implement and/or Execute a Process to Estimate the ROI of Additional Processing that may be Needed for a Post Extracted from a Specific Channel;
Optimize the Content Ingested/Extracted from a Channel;
Extract content (such as a post or posts) from the channel(s) of interest;
Process the extracted content into snippets;
Assemble Corpus of Snippets from the Content Extracted from One or More Channels, Receive/Define a narrative for a specific user, Match/Classify the user narrative(s) to snippets in the corpus that satisfy (match) the narrative;
Enable user to specify keywords or other form of a narrative, specify the processing or operations they desire to be performed on the resulting “matches”, and present results of the further filtering, processing, or other operations to the user.

The application modules and/or sub-modules may include a suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjointed or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjointed or overlapping.

Note that the example computing environments depicted in FIGS. 3-5 are not intended to be limiting examples. Further environments in which an embodiment may be implemented in whole or in part include devices (including mobile devices), software applications, systems, apparatuses, networks, SaaS platforms, laaS (infrastructure-as-a-service) platforms, or other configurable components that may be used by multiple users for data entry, data processing, application execution, or data review (as non-limiting examples).

Embodiments as disclosed and/or described herein can be implemented in the form of control logic using computer software in a modular or integrated manner. Based on the disclosure and teachings provided herein, a person of ordinary skill in the art will know and appreciate other ways and/or methods to implement one or more embodiments using hardware, software, or a combination of hardware and software.

This disclosure includes the following embodiments and clauses:
1. A method of identifying content of concern that has been posted to a social media platform, comprising:
executing one or more computer-implemented processes to
   identify one or more channels of a social media platform that contain posted content of possible interest;
   estimate an expected ROI for each of the one or more channels of the social media platform when used as a source of content for evaluation;
   estimate an expected ROI for additional processing for an item of content posted to and extracted from each of the one or more channels;
   optimize extraction of an item or items of content posted to and extracted from each of the one or more channels, wherein the optimization maximizes the expected ROI subject to a constraint or limit on the use of one or more resources used to extract or process the item or items of content;
   extract one or more items of content from each of the one or more channels;
   process the extracted item or items of content into a snippet or snippets;
   assemble a corpus of snippets from the item or items of content extracted from one or more channels;
   receive or access a narrative for a specific user;
   compare the specific user narrative to one or more snippets in the corpus to determine a snippet or snippets that satisfy the narrative; and
   present results of the comparison to the specific user, wherein the results presented to the user include one or more of an indication of a trend, a link or links to posts of concern or interest, or a notification of an event or action taken in response to the results.
2. The method of clause 1, wherein the process to identify one or more channels of a social media platform that contain posted content of possible interest further comprises use of one or more of contextual data, links, follower/following data, channel metadata, post metadata, crawling/scraping of a webpage, or performing a keyword or semantic search.
3. The method of clause 1, wherein the process to estimate an expected ROI for each of the one or more channels of the social media platform when used as a source of content for evaluation further comprises use of micro scores, wherein a micro score represents a metric indicative of one or more of:
a number of narrative library matches;
a number of overall narrative matches;
a number of overall snippets in corpus or subset of corpus.
4. The method of clause 1, wherein the additional processing for an item of content posted to and extracted from each of the one or more channels includes one or more of Optical Character Recognition, Image Captioning, and Audio Transcription.
5. The method of clause 3, wherein the process to optimize extraction of an item or items of content posted to and extracted from each of the one or more channels further comprises a process based on the micro scores applicable for that channel or based on an “explore and exploit” approach.
6. The method of clause 1, wherein a snippet includes one or more of a post title, post description, or a post hashtag, a transcript from video or audio content, or text contained in an image.
7. The method of clause 1, wherein the narrative for a specific user further comprises a set of keywords connected by one or more Boolean operators.
8. The method of clause 1, wherein comparing the specific user narrative to one or more snippets in the corpus to determine a snippet or snippets that satisfy the narrative further comprises using keyword matching or semantic similarity.
9. The method of clause 1, wherein presenting the results of the matching to the specific user further comprises presenting one or more of a table, a listing, a graph illustrating a trend in snippets satisfying the narrative, a set of links to content, or one or more examples of most relevant snippets and an indication of the match to the narrative.
10. A system, comprising:
one or more electronic processors configured to execute a set of computer-executable instructions; and
the set of computer-executable instructions stored in one or more non-transitory computer-readable media, wherein when executed, the instructions cause the one or more electronic processors to execute a process to
   identify one or more channels of a social media platform that contain posted content of possible interest;
   estimate an expected ROI for each of the one or more channels of the social media platform when used as a source of content for evaluation;
   estimate an expected ROI for additional processing for an item of content posted to and extracted from each of the one or more channels;
   optimize extraction of an item or items of content posted to and extracted from each of the one or more channels, wherein the optimization maximizes the expected ROI subject to a constraint or limit on the use of one or more resources used to extract or process the item or items of content;
   extract one or more items of content from each of the one or more channels;
   process the extracted item or items of content into a snippet or snippets;
   assemble a corpus of snippets from the item or items of content extracted from one or more channels;
   receive or access a narrative for a specific user;
   compare the specific user narrative to one or more snippets in the corpus to determine a snippet or snippets that satisfy the narrative; and
   present results of the comparison to the specific user, wherein the results presented to the user include one or more of an indication of a trend, a link or links to posts of concern or interest, or a notification of an event or action taken in response to the results.
11. One or more non-transitory computer-readable media including a set of computer-executable instructions that when executed by one or more programmed electronic processors, cause the processors to execute a process to:
identify one or more channels of a social media platform that contain posted content of possible interest;
estimate an expected ROI for each of the one or more channels of the social media platform when used as a source of content for evaluation;
estimate an expected ROI for additional processing for an item of content posted to and extracted from each of the one or more channels;
optimize extraction of an item or items of content posted to and extracted from each of the one or more channels, wherein the optimization maximizes the expected ROI subject to a constraint or limit on the use of one or more resources used to extract or process the item or items of content;
extract one or more items of content from each of the one or more channels;
process the extracted item or items of content into a snippet or snippets;
assemble a corpus of snippets from the item or items of content extracted from one or more channels;
receive or access a narrative for a specific user;
compare the specific user narrative to one or more snippets in the corpus to determine a snippet or snippets that satisfy the narrative; and
present results of the comparison to the specific user, wherein the results presented to the user include one or more of an indication of a trend, a link or links to posts of concern or interest, or a notification of an event or action taken in response to the results.

The software components, processes, operations, or functions disclosed and/or described in this application may be implemented as software code or instructions using a computer language such as Python, Java, JavaScript, C, C++, or Perl using conventional or object-oriented techniques. The software code may be stored as a series of instructions or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is a medium suitable for the storage of data or an instruction set aside from a transitory waveform. Such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as a display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive (or similar device), a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or forms of memories based on similar technologies. Such computer-readable storage media allows the processing element or processor(s) to access computer-executable process steps and application programs, stored on removable and non-removable memory media, to off-load data from a device or to upload data to a device.

In some embodiments, certain of the methods, models, processes, operations, or functions disclosed and/or described herein may be embodied in the form of a trained neural network or other form of model derived from a machine learning algorithm. The neural network or model may be implemented by the execution of a set of computer-executable instructions and/or represented as a data structure. The instructions may be stored in (or on) a non-transitory computer-readable medium and executed by a programmed processor or processing element. A neural network or deep learning model may be characterized in the form of a data structure in which are stored data representing a set of layers, with each layer containing a set of nodes, and with connections (and associated weights) between nodes in different layers. The neural network or model operates on an input to provide a decision, prediction, inference, or value as an output.

The set of instructions may be conveyed to a user through a transfer of instructions or an application that executes a set of instructions over a network (e.g., the Internet). The set of instructions or an application may be utilized by an end-user through access to a SaaS platform, self-hosted software, on-premise software, or a service provided through a remote platform.

In general terms, a neural network may be viewed as a system of interconnected artificial “neurons” or nodes that exchange messages between each other. The connections have numeric weights that are “tuned” during a training process, so that a properly trained network will respond correctly when presented with an image, pattern, or set of data. In this characterization, the network consists of multiple layers of feature-detecting “neurons”, where each layer has neurons that respond to combinations of inputs from the previous layers.

Training of a network is performed using a “labeled” dataset of inputs in an assortment of representative input patterns (or datasets) that are associated with their intended output response. Training uses methods to iteratively determine the weights for intermediate and final feature neurons. In terms of a computational model, each neuron calculates the dot product of inputs and weights, adds a bias, and applies a non-linear trigger or activation function (for example, using a sigmoid response function).

Generative artificial intelligence (AI) systems, such as large language models (LLMs), are increasingly being used to synthesize text, assist in complex decision-making tasks, and generate content across a wide range of industries. To leverage generative AI, a model is trained on large-scale corpora of data comprising sequences of tokens (e.g., words or subword units) using machine learning algorithms. During training, the model learns statistical patterns in the input data, typically through an architecture based on transformer neural networks. Each input sequence may be associated with contextual information or objectives (e.g., next-token prediction) that guide the model to learn semantic, syntactic, and factual relationships across the training corpus.

An LLM consists of multiple layers of interconnected processing units that capture hierarchical representations of language. Once training is complete (i.e., model parameters such as weights and biases have been optimized and stabilized), the LLM can receive new input prompts and generate coherent and contextually relevant outputs, such as natural language responses, summaries, translations, or other generative tasks.

As another example, Machine learning (ML) is a technique used to analyze data and assist in making decisions. To benefit from using machine learning, a machine learning algorithm is applied to a set of training data and labels to generate a “model” which represents what the application of the algorithm has “learned” from the training data. Each element (or example) in the form of one or more parameters, variables, characteristics, or “features” of the set of training data is associated with a label or annotation that defines how the element should be classified by the trained model. A trained machine learning model can predict or infer an outcome based on the training data and labels and be used as part of a decision process. When trained, the model will operate on a new element of input data to generate the correct (or most likely correct) label or classification as an output.

Example embodiments of the disclosure are described herein with reference to block diagrams of systems, and/or flowcharts or flow diagrams of functions, operations, processes, or methods. One or more blocks of the block diagrams, or one or more stages or steps of the flowcharts or flow diagrams, and combinations of blocks in the block diagrams and combinations of stages or steps of the flowcharts or flow diagrams may be implemented by computer-executable program instructions. In some embodiments, one or more of the blocks, or stages or steps may not necessarily need to be performed in the order presented or may not necessarily need to be performed at all.

The computer-executable program instructions may be loaded onto a general-purpose computer, a special purpose computer, a processor, or other programmable data processing apparatus to produce a specific example of a machine. The instructions that are executed by the computer, processor, or other programmable data processing apparatus create means for implementing one or more of the functions, operations, processes, or methods disclosed and/or described herein. The computer program instructions may be stored in (or on) a computer-readable memory that may direct a computer or other programmable data processing apparatus to function in a specific manner, such that the instructions stored in (or on) the computer-readable memory produce an article of manufacture including instruction means that when executed implement one or more of the functions, operations, processes, or methods disclosed and/or described herein.

While embodiments of the disclosure have been described in connection with what is presently considered to be the most practical approach and technology, the embodiments are not limited to the disclosed implementations. Instead, the disclosed implementations are intended to include and cover modifications and equivalent arrangements included within the scope of the appended claims. Although specific terms are employed herein, they are used in a generic and descriptive sense only and not for purposes of limitation.

This written description uses examples to describe one or more embodiments of the disclosure, and to enable a person skilled in the art to practice the disclosed approach and technology, including making and using devices or systems and performing the associated methods. The patentable scope of the disclosure is defined by the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents cited herein are hereby incorporated by reference to the same extent as if each reference was individually and specifically indicated to be incorporated by reference and/or was set forth in its entirety herein.

The use of the terms “a” and “an” and “the” and similar references in the specification and in the claims are to be construed to cover both the singular and the plural, unless otherwise indicated herein or clearly contradicted by context. The terms “having,” “including,” “containing” and similar references in the specification and in the claims are to be construed as open-ended terms (e.g., meaning “including, but not limited to,”) unless otherwise noted.

Recitation of ranges of values herein are intended to serve as a shorthand method of referring individually to each separate value inclusively falling within the range, unless otherwise indicated herein, and each separate value is incorporated into the specification as if it were individually recited herein. Method steps or stages disclosed and/or described herein may be performed in any suitable order unless otherwise indicated herein or clearly contradicted by context.

The use of examples or exemplary language (e.g., “such as”) herein, is intended to illustrate embodiments of the disclosure and does not pose a limitation to the scope of the claims unless otherwise indicated. No language in the specification should be construed as indicating any non-claimed element as essential to each embodiment of the disclosure.

As used herein (i.e., the claims, figures, and specification), the term “or” is used inclusively to refer items in the alternative and in combination.

Different arrangements of the elements, structures, components, or steps illustrated in the figures or described herein, as well as components and steps not shown or described are possible. Similarly, some features and sub-combinations are useful and may be employed without reference to other features and sub-combinations. Embodiments have been described for illustrative and not for restrictive purposes, and alternative embodiments may become apparent to readers of the specification. Accordingly, the disclosure is not limited to the embodiments described in the specification or depicted in the figures, and modifications may be made without departing from the scope of the appended claims.

That which is claimed is:

1. A method of identifying content of concern that has been posted to a social media platform, comprising:
executing one or more computer-implemented processes to
identify one or more channels of a social media platform that contain posted content of possible interest;
estimate an expected ROI for each of the one or more channels of the social media platform when used as a source of content for evaluation;
estimate an expected ROI for additional processing for an item of content posted to and extracted from each of the one or more channels;
optimize extraction of an item or items of content posted to and extracted from each of the one or more channels, wherein the optimization maximizes the expected ROI subject to a constraint or limit on the use of one or more resources used to extract or process the item or items of content;
extract one or more items of content from each of the one or more channels;
process the extracted item or items of content into a snippet or snippets;
assemble a corpus of snippets from the item or items of content extracted from one or more channels;
receive or access a narrative for a specific user;
compare the specific user narrative to one or more snippets in the corpus to determine a snippet or snippets that satisfy the narrative; and
present results of the comparison to the specific user, wherein the results presented to the user include one or more of an indication of a trend, a link or links to posts of concern or interest, or a notification of an event or action taken in response to the results.

2. The method of claim 1, wherein the process to identify one or more channels of a social media platform that contain posted content of possible interest further comprises use of one or more of contextual data, links, follower/following data, channel metadata, post metadata, crawling/scraping of a webpage, or performing a keyword or semantic search.

3. The method of claim 1, wherein the process to estimate an expected ROI for each of the one or more channels of the social media platform when used as a source of content for evaluation further comprises use of micro scores, wherein a micro score represents a metric indicative of one or more of:
a number of narrative library matches;
a number of overall narrative matches;
a number of overall snippets in corpus or subset of corpus.

4. The method of claim 1, wherein the additional processing for an item of content posted to and extracted from each of the one or more channels includes one or more of Optical Character Recognition, Image Captioning, and Audio Transcription.

5. The method of claim 3, wherein the process to optimize extraction of an item or items of content posted to and extracted from each of the one or more channels further comprises a process based on the micro scores applicable for that channel or based on an “explore and exploit” approach.

6. The method of claim 1, wherein a snippet includes one or more of a post title, post description, or a post hashtag, a transcript from video or audio content, or text contained in an image.

7. The method of claim 1, wherein the narrative for a specific user further comprises a set of keywords connected by one or more Boolean operators.

8. The method of claim 1, wherein comparing the specific user narrative to one or more snippets in the corpus to determine a snippet or snippets that satisfy the narrative further comprises using keyword matching or semantic similarity.

9. The method of claim 1, wherein presenting the results of the matching to the specific user further comprises presenting one or more of a table, a listing, a graph illustrating a trend in snippets satisfying the narrative, a set of links to content, or one or more examples of most relevant snippets and an indication of the match to the narrative.

10. A system, comprising:
one or more electronic processors configured to execute a set of computer-executable instructions; and
the set of computer-executable instructions stored in one or more non-transitory computer-readable media, wherein when executed, the instructions cause the one or more electronic processors to execute a process to
identify one or more channels of a social media platform that contain posted content of possible interest;
estimate an expected ROI for each of the one or more channels of the social media platform when used as a source of content for evaluation;
estimate an expected ROI for additional processing for an item of content posted to and extracted from each of the one or more channels;
optimize extraction of an item or items of content posted to and extracted from each of the one or more channels, wherein the optimization maximizes the expected ROI subject to a constraint or limit on the use of one or more resources used to extract or process the item or items of content;
extract one or more items of content from each of the one or more channels;
process the extracted item or items of content into a snippet or snippets;
assemble a corpus of snippets from the item or items of content extracted from one or more channels;
receive or access a narrative for a specific user;
compare the specific user narrative to one or more snippets in the corpus to determine a snippet or snippets that satisfy the narrative; and
present results of the comparison to the specific user, wherein the results presented to the user include one or more of an indication of a trend, a link or links to posts of concern or interest, or a notification of an event or action taken in response to the results.

11. The system of claim 10, wherein the process to identify one or more channels of a social media platform that contain posted content of possible interest further comprises use of one or more of contextual data, links, follower/following data, channel metadata, post metadata, crawling/scraping of a webpage, or performing a keyword or semantic search.

12. The system of claim 10, wherein the process to estimate an expected ROI for each of the one or more channels of the social media platform when used as a source of content for evaluation further comprises use of micro scores, wherein a micro score represents a metric indicative of one or more of:
a number of narrative library matches;
a number of overall narrative matches;
a number of overall snippets in corpus or subset of corpus.

13. The system of claim 10, wherein the additional processing for an item of content posted to and extracted from each of the one or more channels includes one or more of Optical Character Recognition, Image Captioning, and Audio Transcription.

14. The system of claim 10, wherein a snippet includes one or more of a post title, post description, or a post hashtag, a transcript from video or audio content, or text contained in an image.

15. The system of claim 10, wherein the narrative for a specific user further comprises a set of keywords connected by one or more Boolean operators, and wherein comparing the specific user narrative to one or more snippets in the corpus to determine a snippet or snippets that satisfy the narrative further comprises using keyword matching or semantic similarity.

16. The system of claim 10, wherein presenting the results of the matching to the specific user further comprises presenting one or more of a table, a listing, a graph illustrating a trend in snippets satisfying the narrative, a set of links to content, or one or more examples of most relevant snippets and an indication of the match to the narrative.

17. One or more non-transitory computer-readable media including a set of computer-executable instructions that when executed by one or more programmed electronic processors, cause the processors to execute a process to:
identify one or more channels of a social media platform that contain posted content of possible interest;
estimate an expected ROI for each of the one or more channels of the social media platform when used as a source of content for evaluation;
estimate an expected ROI for additional processing for an item of content posted to and extracted from each of the one or more channels;
optimize extraction of an item or items of content posted to and extracted from each of the one or more channels, wherein the optimization maximizes the expected ROI subject to a constraint or limit on the use of one or more resources used to extract or process the item or items of content;
extract one or more items of content from each of the one or more channels;
process the extracted item or items of content into a snippet or snippets;
assemble a corpus of snippets from the item or items of content extracted from one or more channels;
receive or access a narrative for a specific user;
compare the specific user narrative to one or more snippets in the corpus to determine a snippet or snippets that satisfy the narrative; and
present results of the comparison to the specific user, wherein the results presented to the user include one or more of an indication of a trend, a link or links to posts of concern or interest, or a notification of an event or action taken in response to the results.

18. The one or more non-transitory computer-readable media of claim 17, wherein the process to identify one or more channels of a social media platform that contain posted content of possible interest further comprises use of one or more of contextual data, links, follower/following data, channel metadata, post metadata, crawling/scraping of a webpage, or performing a keyword or semantic search, and wherein the process to estimate an expected ROI for each of the one or more channels of the social media platform when used as a source of content for evaluation further comprises use of micro scores, wherein a micro score represents a metric indicative of one or more of:
a number of narrative library matches;
a number of overall narrative matches;
a number of overall snippets in corpus or subset of corpus.

19. The one or more non-transitory computer-readable media of claim 17, wherein a snippet includes one or more of a post title, post description, or a post hashtag, a transcript from video or audio content, or text contained in an image.

20. The one or more non-transitory computer-readable media of claim 17, wherein the narrative for a specific user further comprises a set of keywords connected by one or more Boolean operators, and wherein comparing the specific user narrative to one or more snippets in the corpus to determine a snippet or snippets that satisfy the narrative further comprises using keyword matching or semantic similarity.
